(19) United States
(12) Patent Application Publication
(10) Pub. No.: US 2010/0188721 A1
(43) Pub. Date: Jul. 29, 2010

(54) TWO-DIMENSIONAL ENCODER, HOLOGRAPHIC MEMORY DEVICE AND HOLOGRAPHIC MEMORY MEDIUM

(76) Inventors: Yuji Takagi, Osaka (JP); Makoto Usui, Osaka (JP); Kenichi Kasazumi, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/439,688

(22) PCT Filed: Oct. 3, 2007
(86) PCT No.: PCT/JP2007/069792

§ 371 Date: Mar. 3, 2009

(30) Foreign Application Priority Data
Oct. 5, 2006 (JP) 2006-274453
Mar. 2, 2007 (JP) 2007-052459
Apr. 11, 2007 (JP) 2007-103624

(51) Int. Cl. G03H 1/04

(52) U.S. Cl. 359/21

(57) ABSTRACT

A two-dimensional encoder stores data on a holographic memory. The encoder encodes data of k bits (where k is an integer and k≧3) into n pixels arranged two-dimensionally (where n is an integer and n≧6). The encoder includes a first processing section 31 for classifying the n pixels into first and second groups of subblocks 11 and 12 using k1 bits out of the data of k bits (where k1 is an integer and k1≧1). Each of the subblocks 11 in the first group consists of m pixels (where m is an integer and m≧2), and the number of the subblocks 11 forming the first group is s1 (where s1 is an integer and s1≧2). Each of the subblocks 12 in the second group also consists of m pixels, and the number of the subblocks 12 forming the second group is s2 (where s2 is an integer and s2≧1). The encoder further includes a second processing section 32 for turning ON p pixels (where p is an integer and 1≦p≦m/2) out of the m pixels forming each subblock 11 in the first group and turning OFF all of the m pixels forming each subblock 12 in the second group using the other k2 bits of the data of k bits (where k2=k−k1).

### TECHNICAL FIELD

The present invention relates to holographic memory technologies for storing two-dimensionally encoded data by recording interference fringes of light waves.

### BACKGROUND ART

Recently, holographic memories have attracted a lot of attention as optical storage media that have much bigger storage capacities than DVDs and various other currently available storage media. A holographic memory is typically made of a photorefractive material and can record interference fringes, formed by an optical signal beam (or object light) and a reference beam, as a spatial distribution of refractive indices.

A holographic memory device can encode data two-dimensionally and store it on a holographic memory medium on a page-by-page basis. The two-dimensionally encoded data is generated from the optical signal beam by a two-dimensional spatial light modulator such as an LCD panel.

In a spatial light modulator, a huge number of pixels are arranged in columns and rows and can be turned ON or OFF independently of each other. As used herein, an “ON-state pixel” refers to a pixel that can transmit light and an “OFF-state pixel” refers to a pixel that cuts off light. By turning such a lot of pixels ON or OFF independently, the spatial light modulator can represent any bit pattern arbitrarily.

When a light beam functioning as an optical signal beam is transmitted through such a spatial light modulator, the intensity of the light beam is spatially modulated according to the two-dimensional pattern defined by the ON- and OFF-states of those pixels on the spatial light modulator. And if such a modulated light beam is incident as an optical signal beam on a holographic memory medium, the interference fringes, formed between the optical signal beam and the reference beam, are recorded on the holographic memory medium. This recording operation can be done on the same portion of the medium a number of times by changing the angles or points of incidence of the light on the holographic memory medium. That is why data of a huge size can be stored on such a medium.

To read the data stored there, the holographic memory medium is irradiated with a laser beam or any other read light beam. As the read light beam, the same light beam as the reference beam for writing may be used. When the read light beam is incident on the holographic memory medium, the read light beam (or reference beam) is diffracted by the interference fringes that have been recorded in the medium. This diffracted light reproduces the pattern of the optical signal beam that was used to record those interference fringes (i.e., the light beam that was modulated by the spatial light modulator). By detecting this diffracted light with a two-dimensional photodetector such as a CCD, the bit pattern on the spatial light modulator during the recording operation can be reproduced.

As a two-dimensional code for holographic memories, a 2-4 code, in which a small block is formed by four pixels (i.e., 2×2 pixels), was proposed (see Patent Document No. 1, for example). According to this 2-4 code, only one of the four pixels is turned ON (i.e., turned into a light-transmitting pixel) and the other three are turned OFF (i.e., turned into light-cutting pixels). In this manner, information of two bits can be encoded into a four-bit pattern.

On the other hand, as it is very easy to determine the ON and OFF states during reading, another code, in which the rate of ON-state pixels per code element (which will be referred to herein as an “ON rate”) is kept constant by turning ON only q pixels out of a predetermined number p of pixels, has also been proposed. For example, according to a code proposed, only two out of nine pixels (i.e., 3×3 pixels) are turned ON (see Patent Document No. 2, for example).

In any of these two-dimensional codes, the number of ON-state pixels per code element is constant. That is why in telling ON-state pixels from OFF-state pixels during reading, a predetermined number of pixels with highest intensities can be detected as the ON-state pixels without performing slice detection with respect to the reference level. As a result, the read operation can be performed with an even smaller number of errors and with more reliability.

Also, the lower the ON rate of these codes, the better the SNR (i.e., an index of read performance) tends to be. Specifically, the lower the ON rate, the less likely a number of ON-state pixels are adjacent to each other either within a single code element or between a plurality of code elements. If a plurality of ON-state pixels were adjacent to each other, then intersymbol interference would occur to generate read errors more often. By reducing the ON rate according to the coding method described above, however, not only the intersymbol interference but also the probability of medium saturation can be reduced.

In the two-dimensional code in which only q out of p pixels are turned ON, the ON rate can be reduced by increasing the code element size (i.e., by increasing p). For example, in a code in which just one out of four pixels is turned ON, the number of possible code pattern combinations is four (i.e., Combination (4, 1)=4). As used herein, Combination (a, b) means the number of possible combinations in a situation where a number b of items need to be selected out of a number a of items. Since 2² bits=4, a code element consisting of four pixels (i.e., four bits) can be defined for data of two bits. In this case, the coding rate=2/4=0.5 and the ON rate is 1/4=0.25.

On the other hand, in a code in which just three out of sixteen pixels is turned ON, the number of possible code pattern combinations is 560 (i.e., Combination (16, 3)=560). Since 2⁹ bits=512, a code element consisting of sixteen pixels (i.e., sixteen bits) can be defined for data of nine bits. In this case, the coding rate=9/16=0.5625 and the ON rate is 3/16=0.1875. Optionally, by using only 256 patterns out of the possible 560 code patterns, the coding rate can be reduced to 8/16=0.5.

Furthermore, in a code in which just three out of twenty pixels is turned ON, Combination (20, 3)=1,140. Since 2¹⁰ bits=1,024, a code element consisting of twenty pixels (i.e., twenty bits) can be defined for data of ten bits. In this case, the coding rate=10/20=0.5 and the ON rate is 3/20=0.15.

According to these two-dimensional codes, if the coding rate is constant, the ON rate can be reduced by increasing the code element size. As a result, a code with good read performance can be provided.
Patent Document No. 1: Japanese Patent Application Laid-Open Publication No. 9-197947
Patent Document No. 2: Japanese Patent Application Laid-Open Publication No. 2001-75463

If the code element size is increased, however, the sizes of encoding and decoding circuits increase. Among other things, the size of a decoding table for use in a decoding operation increases significantly. For example, a 2-4 code in which only one out of four pixels is turned ON needs a conversion table of two bits and a conversion table of four bits. The size of the decoding table, in particular, will be 2⁴×2 bits=16×2 bits.

On the other hand, a code in which only three out of sixteen pixels are turned ON needs a conversion table of eight bits and a conversion table of sixteen bits. The size of the decoding table, in particular, will be 2¹⁶×8 bits=64 KB. Furthermore, a code in which only three out of twenty pixels are turned ON needs a conversion table of ten bits and a conversion table of twenty bits. The size of the decoding table, in particular, will be 2²⁰×10 bits=1 megaword. In that case, a ROM table with a huge capacity will be needed.

In order to overcome the problems described above, an object of the present invention is to provide a two-dimensional encoder, a holographic memory device, and a holographic memory medium that can reduce the ON rate while minimizing the increase in the sizes of the encoding and decoding circuits.

### DISCLOSURE OF INVENTION

A two-dimensional encoder according to the present invention is designed to store data on a holographic memory. The encoder encodes data of k bits (where k is an integer and k≧3) into a number n of pixels that are arranged two-dimensionally (where n is an integer and n≧6). The encoder includes a first processing section for classifying the n pixels into first and second groups of subblocks using k1 bits out of the data of k bits (where k1 is an integer and k1≧1). Each of the subblocks in the first group consists of a number m of pixels (where m is an integer and m≧2), and the number of the subblocks forming the first group is s1 (where s1 is an integer and s1≧2). Each of the subblocks in the second group also consists of m pixels, and the number of the subblocks forming the second group is s2 (where s2 is an integer and s2≧1). The encoder further includes a second processing section for turning ON a number p of pixels (where p is an integer and 1≦p≦m/2) out of the m pixels forming each subblock in the first group and turning OFF all of the m pixels forming each subblock in the second group using the other k2 bits of the data of k bits (where k2=k−k1).

In one preferred embodiment of the present invention, m is one of 2, 4 and 16.

In this particular preferred embodiment, if m=2 or 4, then p=1, but if m=16, then p=3.

In a specific preferred embodiment, if m=2, then s1=9 and s2=6. If m=4, then s1=5 and s2=13. And if m=16, then s1=3 and s2=1.

In another preferred embodiment, k/n=0.5.

Another two-dimensional encoder according to the present invention is designed to store data on a holographic memory. The encoder generates two-dimensionally encoded data based on write data to be encoded. The two-dimensionally encoded data has a structure in which a number of subblocks are arranged in columns and rows. Each subblock includes a first pixel and a second pixel that are arranged in the same order in a particular direction that is parallel to either the rows or the columns. The encoder includes a first processing section for determining, based on the write data, the ON and OFF states of the subblocks and a second processing section for turning ON one of the first and second pixels in each of the subblocks that have been determined to turn ON among the subblocks. If the particular direction is parallel to the rows and if the subblock that has been determined to turn ON belongs to an odd-numbered row, the second processing section turns ON the first pixel of the subblock. But if the subblock that has been determined to turn ON belongs to an even-numbered row, the second processing section turns ON the second pixel of the subblock. On the other hand, if the particular direction is parallel to the columns and if the subblock that has been determined to turn ON belongs to an odd-numbered column, the second processing section turns ON the first pixel of the subblock. But if the subblock that has been determined to turn ON belongs to an even-numbered column, the second processing section turns ON the second pixel of the subblock.

In one preferred embodiment of the present invention, the first processing section turns ON a number n of subblocks (where n is an integer and n≧1) among the subblocks, of which is the total number is m (where m is an integer and m≧2).

A holographic memory device according to the present invention is designed to write two-dimensionally encoded data on a holographic memory medium. The memory device includes: a light source for emitting an optical signal beam and a reference beam; a spatial light modulator, which includes a plurality of pixels that are arranged two-dimensionally and which controls transmission and cutoff of the optical signal beam on a pixel-by-pixel basis, thereby turning ON or OFF the respective pixels; a two-dimensional encoder according to any of the preferred embodiments of the present invention described above for generating the two-dimensionally encoded data for use to drive the spatial light modulator; and an optical system for irradiating the holographic memory medium with the reference beam and the optical signal beam that has been modulated by the spatial light modulator.

In one preferred embodiment of the present invention, the holographic memory device further includes: a measuring section for counting the number of other ON-state pixels that are included in a plurality of pixels adjacent to each ON-state pixel on the spatial light modulator; and a transmittance changing section for adjusting the transmittance of each ON-state pixel according to the number of the other ON-state pixels that are included in the pixels adjacent to the ON-state pixel.

In this particular preferred embodiment, if the transmittances of an OFF-state pixel, an ON-state pixel with no adjacent ON-state pixels, and an ON-state pixel with an adjacent ON-state pixel are identified by T0, T1 and T2, respectively, the transmittance changing section adjusts the transmittances of the respective pixels of the spatial light modulator such that T0<T2<T1 is satisfied.

In a specific preferred embodiment, the measuring section counts the number of the ON-state pixels included in eight pixels that are vertically, horizontally and diagonally adjacent to each ON-state pixel.

In that case, if the number of the ON-state pixels included in the eight pixels that are vertically, horizontally and diagonally adjacent to each ON-state pixel is n and if a is a predetermined number that is less than one, the transmittance changing section adjusts the transmittance of each pixel of the spatial light modulator such that T2=T1×(a)̂n (where ̂ denotes a power) is satisfied.

In another preferred embodiment, in counting the number of the ON-state pixels included in eight pixels that are vertically, horizontally and diagonally adjacent to each ON-state pixel, the measuring section multiplies the number of the ON-state pixels, included in the four pixels that are diagonally adjacent to the ON-state pixel, by a coefficient that is equal to or greater than zero but less than one.

A holographic memory medium according to the present invention stores two-dimensionally encoded data, in which data of k bits (where k is an integer and k≧3) has been encoded into a number n of pixels that are arranged two-dimensionally (where n is an integer and n≧6). The n pixels are classified into first and second groups of subblocks, thereby representing k1 bits (where k1 is an integer and k1≧1) out of the data of k bits. Each of the subblocks in the first group consists of a number m of pixels (where m is an integer and m≧2) and the number of the subblocks forming the first group is s1 (where s1 is an integer and s1≧2). Each of the subblocks in the second group also consists of m pixels, and the number of the subblocks forming the second group is s2 (where s2 is an integer and s2≧1). A number p of pixels (where p is an integer and 1≦p≦m/2) out of the m pixels forming each subblock in the first group are ON-state pixels and all of the m pixels forming each subblock in the second group are OFF-state pixels, thereby representing the other k2 bits of the data of k bits (where k2=k−k1) by the arrangement of the respective pixels in each subblock.

Another holographic memory medium according to the present invention also stores two-dimensionally encoded data. The two-dimensionally encoded data has a structure in which a number of subblocks are arranged in columns and rows. Each subblock includes a first pixel and a second pixel that are arranged in the same order in a particular direction that is parallel to either the rows or the columns. If the particular direction is parallel to the rows and if a subblock including an ON-state pixel belongs to an odd-numbered row, the first pixel included in the subblock is selected as the ON-state pixel. But if the subblock including the ON-state pixel belongs to an even-numbered row, the second pixel included in the subblock is selected as the ON-state pixel. On the other hand, if the particular direction is parallel to the columns and if a subblock including an ON-state pixel belongs to an odd-numbered column, the first pixel included in the subblock is selected as the ON-state pixel. But if the subblock including the ON-state pixel belongs to an even-numbered column, the second pixel included in the subblock is selected as the ON-state pixel.

A two-dimensional encoding method according to the present invention is designed to store data on a holographic memory. According to this method, data of k bits (where k is an integer and k≧3) is encoded into a number n of pixels that are arranged two-dimensionally (where n is an integer and n≧6). The method includes a first processing step of classifying the n pixels into first and second groups of subblocks using k1 bits out of the data of k bits (where k1 is an integer and k1≧1). Each of the subblocks in the first group consists of a number m of pixels (where m is an integer and m≧2). The number of the subblocks forming the first group is s1 (where s1 is an integer and s1≧2). Each of the subblocks in the second group also consists of m pixels, and the number of the subblocks forming the second group is s2 (where s2 is an integer and s2≧1). The method further includes a second processing step for turning ON a number p of pixels (where p is an integer and 1≦p≦m/2) out of the m pixels forming each subblock in the first group and turning OFF all of the m pixels forming each subblock in the second group using the other k2 bits of the data of k bits (where k2=k−k1).

Another two-dimensional encoding method according to the present invention is designed to store data on a holographic memory. According to this method, two-dimensionally encoded data is generated based on write data to be encoded. The two-dimensionally encoded data has a structure in which a number of subblocks are arranged in columns and rows. Each subblock includes a first pixel and a second pixel that are arranged in the same order in a particular direction that is parallel to either the rows or the columns. The method includes a first processing step for determining, based on the write data, the ON and OFF states of the subblocks and a second processing step for turning ON one of the first and second pixels in each of the subblocks that have been determined to turn ON among the subblocks. If the particular direction is parallel to the rows and if the subblock that has been determined to turn ON belongs to an odd-numbered row, the second processing step includes turning ON the first pixel of the subblock. But if the subblock that has been determined to turn ON belongs to an even-numbered row, the second processing step includes turning ON the second pixel of the subblock. If the particular direction is parallel to the columns and if the subblock that has been determined to turn ON belongs to an odd-numbered column, the second processing step includes turning ON the first pixel of the subblock. But if the subblock that has been determined to turn ON belongs to an even-numbered column, the second processing step includes turning ON the second pixel of the subblock.

According to a first aspect of the present invention, a number of pixels are classified into a first group of subblocks and a second group of subblocks and a predetermined number of ON-state pixels are arranged in only the subblocks in the first group. As a result, the ON rate can be reduced with the increase in the sizes of circuits for encoding and decoding minimized.

Also, according to a second aspect of the present invention, no ON-state pixels are adjacent to each other vertically or horizontally in an arrangement of pixels, and therefore, read errors can be reduced.

Furthermore, according to a third aspect of the present invention, even if ON-state pixels are adjacent to each other either vertically or horizontally in an arrangement of pixels, read errors can also be reduced by adjusting the optical transmittance of those ON-state pixels.

Other features, elements, processes, steps, characteristics and advantages of the present invention will become more apparent from the following detailed description of preferred embodiments of the present invention with reference to the attached drawings.

### BRIEF DESCRIPTION OF DRAWINGS

FIG. 1 shows an exemplary pixel pattern for two-dimensionally encoded data according to a first preferred embodiment of the present invention.

FIG. 2 shows the process of generating two-dimensionally encoded data according to the first preferred embodiment.

FIG. 3 is a block diagram of a two-dimensional encoder according to the first preferred embodiment.

FIG. 4 shows an exemplary pixel pattern for two-dimensionally encoded data according to a second preferred embodiment of the present invention.

FIG. 5 shows the process of generating two-dimensionally encoded data according to the second preferred embodiment.

FIG. 6 is a block diagram of a two-dimensional encoder according to the second preferred embodiment.

FIG. 7 is a block diagram of a holographic memory device according to a third preferred embodiment of the present invention.

FIG. 8 shows an exemplary pixel pattern for two-dimensionally encoded data according to a fourth preferred embodiment of the present invention.

FIG. 9 shows the process of generating two-dimensionally encoded data according to the fourth preferred embodiment.

FIG. 10 is a block diagram of a two-dimensional encoder according to the fourth preferred embodiment.

FIG. 11 shows an exemplary pixel pattern for two-dimensionally encoded data according to a fifth preferred embodiment of the present invention.

FIG. 12 shows the process of generating two-dimensionally encoded data according to the fifth preferred embodiment.

FIG. 13 is a block diagram of a two-dimensional encoder according to the fifth preferred embodiment.

FIG. 14 shows an exemplary pixel pattern for two-dimensionally encoded data according to a sixth preferred embodiment of the present invention.

FIG. 15 shows exemplary transmittances of respective ON-state pixels of a spatial light modulator according to the sixth preferred embodiment.

FIG. 16 is a block diagram of a transmittance setter for determining the transmittances of respective ON-state pixels according to the sixth preferred embodiment.

FIG. 17 is a block diagram of a holographic memory read/write device according to the sixth preferred embodiment.

### DESCRIPTION OF REFERENCE NUMERALS

11, 41 subblock in a first group
12, 42 subblock in a second group
30, 60 ROM table
31, 61 first processing section
32, 62, 103 second processing section
81 subblock
82 write data
94 write data
98 two-dimensionally encoded data
101 first processing section
102 row forming section
103 second processing section
111 subblock
113 block
128 two-dimensionally encoded data
131 first processing section
132 row forming section
133 second processing section
161 two-dimensionally encoded data
162 measuring section
163 transmittance changing section
701 laser beam source
702 beam expander
703 half mirror
704 condenser lens
705 holographic memory medium
706 Fourier transform lens
707 photodetector
708 reference beam
709 read signal
710 mirror
711 spatial light modulator
712 two-dimensionally encoded data
713 optical signal beam
714 two-dimensional encoder
715 error correction coder
716 data
717 write data
718 transmittance setter

### BEST MODE FOR CARRYING OUT THE INVENTION

Hereinafter, preferred embodiments of the present invention will be described with reference to the accompanying drawings.

### Embodiment 1

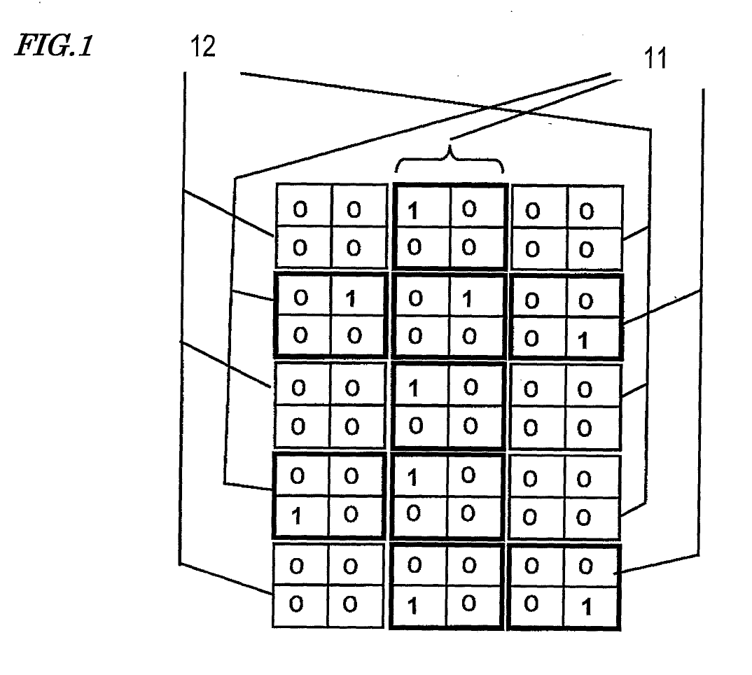

FIG. 1 shows an exemplary pixel pattern for two-dimensionally encoded data according to a first preferred embodiment of the present invention. The two-dimensionally encoded data shown in FIG. 1 is obtained by encoding data of k bits into a number n of pixels that are arranged two-dimensionally. In this example, n=10×6=60, k is an integer that is equal to or greater than three, and n is an integer that is equal to or greater than six.

As shown in FIG. 1, one of the two Arabic numerals “0” and “1” is allocated to each of these pixels. A “zero” pixel corresponds to an “OFF-state pixel”, while a “one” pixel corresponds to an “ON-state pixel”. As will be described in detail later, such two-dimensionally encoded data is converted by a spatial light modulator into a two-dimensional pattern of bright and dark pixels. The spatial light modulator can cut off an optical signal beam at the OFF-state pixels and can transmit the optical signal beam through the ON-state pixels. A single spatial light modulator has a huge number of pixels (which may be as many as one million pixels, for example) and can display a number of light transmitting/cutting patterns, corresponding to the two-dimensionally encoded data shown in FIG. 1, at the same time.

The n pixels shown in FIG. 1 are classified into first and second groups of subblocks 11 and 12. Each of the subblocks 11 in the first group consists of a number m of pixels (where m is an integer and m≧2), and the number of the subblocks forming the first group 11 is s1 (where s1 is an integer and s1≧2). Each of the subblocks 12 in the second group also consists of m pixels, and the number of the subblocks 12 forming the second group is s2 (where s2 is an integer and s2≧1). In this preferred embodiment, m=4 and every subblock 11, 12 consists of 2×2 pixels.

Since the total number of the subblocks in the first and second groups is (s1+s2) and since each subblock 11, 12 consists of m pixels, m×(s1+s2)=n is satisfied.

As shown in FIG. 1, in each of these subblocks 11 in the first group, only p out of the m pixels (p=1 in this example) is an ON-state pixel but the other (m−p) pixels are OFF-state pixels. On the other hand, in each subblock 12 in the second group, all of the m pixels thereof are OFF-state pixels. That is why the total number of ON-state pixels in the n (=60) pixels can be given by s1×p.

In the example shown in FIG. 1, a single two-dimensional code consists of n pixels, which are classified into s1 (=9) subblocks 11 in the first group and s2 (=6) subblocks 12 in the second group. The total number of arrangements of the nine subblocks 11 in the first group and the six subblocks 12 in the second group is Combination (15, 9)=5,005. Since 2¹² bits=4,096, data of 12 bits can be represented by the combinations of arrangements of the first and second groups of subblocks 11 and 12.

On the other hand, in each subblock 11 in the first group, just one of the four pixels is an ON-state pixel. That is why the only ON-state pixel has four possible locations in each subblock 11 in the first group. Since 2² bits=4, data of 2 bits can be represented by the location of the ON-state pixel in a single subblock 11 in the first group. Consequently, the nine subblocks 11 in the first group can represent data of 18 bits (=2 bits×9) overall.

As described above, the two-dimensional code of the first preferred embodiment shown in FIG. 1 can represent data of 12 bits by combining the arrangements of the subblocks 11, 12 in the first and second groups and can also represent data of 18 bits by the locations of the ON-state pixels in the respective subblocks 11 in the first group. Consequently, a single code of 60 pixels can represent data of 30 bits (=12 bits+18 bits) and the coding rate (k/n) is 30/60=0.5. Also, since the number of the subblocks 11 in the first group, in each of which only one of the four pixels is an ON-state pixel, is nine, the ON rate ((s1×p)/n) is 9/60=0.15.

The two-dimensional code of this preferred embodiment can be encoded and decoded using one of the following conversion tables.

### First Conversion Table

A first conversion table is a table for associating the combinations of arrangements of 15 (=n/m) subblocks in total, consisting of the first and second groups of subblocks 11 and 12, with data of 12 bits. The size of this decoding table is 2¹⁵×12 bits=32 kilowords, while that of an encoding table is 2¹²×15 bits=4 kilowords.

### Second Conversion Table

A second conversion table is a table for associating the locations of the ON-state pixels in the respective subblocks 11 in the first group with the data of 2 bits. A decoding table needs to have a size of 2⁴×2 bits, while an encoding table needs to have a size of 2²×4 bits. Encoding and decoding operations with the second conversion table may be carried out by either using a single table nine times or preparing nine different tables and using them in parallel with each other. In any case, the size of the second conversion table for performing these encoding and decoding operations is much smaller than that of the first conversion table. Consequently, the overall size of circuits to implement the first and second conversion tables will be approximately comparable to a ROM table with a size of about 32 kilowords in case of decoding or a ROM table with a size of about 4 kilowords in case of encoding.

On the other hand, according to a conventional code in which three out of twenty pixels are turned ON, the ON rate thereof is 0.15, which is equal to that of this preferred embodiment. However, the conversion needs to be performed using a conversion table between 10 bits and 20 bits. Among other things, the size of the decoding table is 2²⁰×10 bits=1 megaword, thus requiring a ROM table with a huge storage capacity. Consequently, by using the two-dimensional code of this preferred embodiment, decoding can be done with a decoding table of a smaller size.

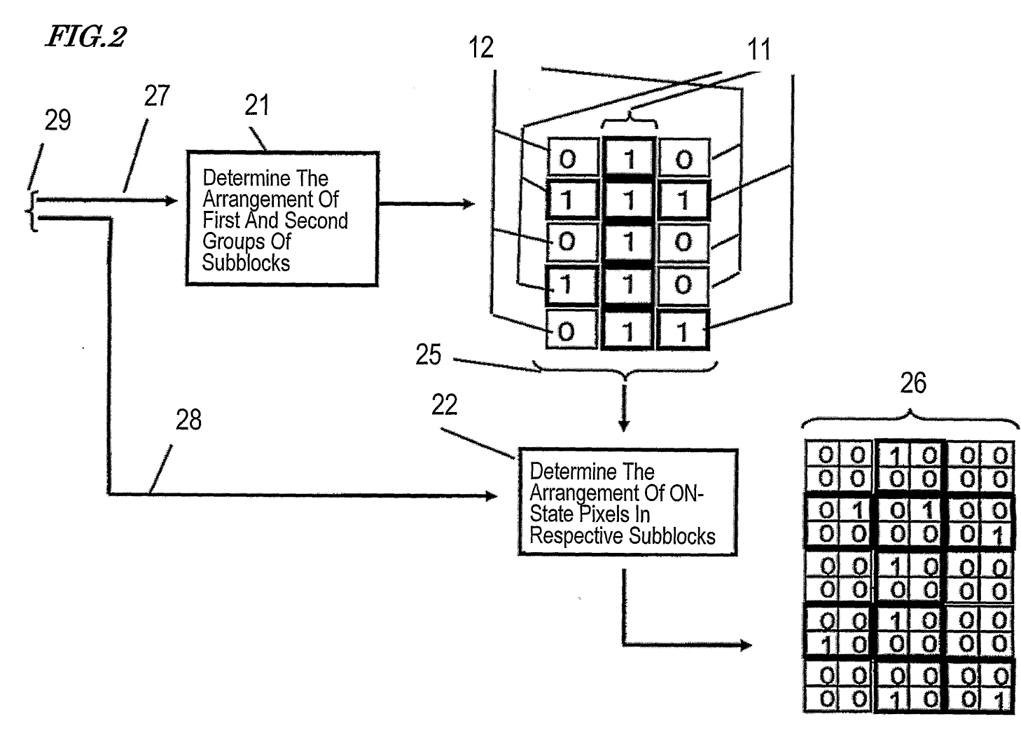

Next, a method for generating two-dimensionally encoded data according to this preferred embodiment will be described with reference to FIG. 2. In this preferred embodiment, the arrangement of the first and second groups of subblocks 11 and 12 is determined in Step S21 and then the arrangement of the ON-state pixels in the respective subblocks is determined in Step S22 as shown in FIG. 2.

Specifically, in this preferred embodiment, data 29 of k (=30) bits is received and split into data 27 of k1 (=12) bits and data 28 of k2 (=18) bits, which are then encoded separately from each other (k=k1+k2). More specifically, first, in Step S21, using the data 27 of k1 (=12) bits, a number n (=60) of pixels are classified into a number s1 (=9) of subblocks 11 to form a first group and a number s2 (=6) of subblocks 12 to form a second group and their arrangement is determined.

FIG. 2 shows an example of subblock arrangement 25 that has been determined in this manner. In the subblock arrangement 25, “1” denotes a subblock 11 in the first group and “0” denotes a subblock 12 in the second group. The total number of combinations of arrangements of the nine subblocks 11 in the first group and the six subblocks 12 in the second group is Combination (15, 9)=5,005. Since 2¹² bits=4,096, data 27 of 12 bits can be encoded uniquely into an arrangement of the subblocks 11, 12 by defining in advance 4,096 different combinations of arrangements of the first and second groups of subblocks 11 and 12 out of the 5,005 combinations.

Next, in Step S22, using the data 28 of 18 bits, the locations of the ON-state pixels in the respective subblocks 11 in the first group are determined. In each subblock 11 in the first group, only one of the four pixels is an ON-state pixel. That is why the only ON-state pixel has four possible locations. Since 2² bits=4, data of 2 bits can be represented by a single subblock 11 in the first group. Consequently, the nine subblocks 11 in the first group can represent data of 18 bits (=2 bits×9) overall. Consequently, the location of the ON-state pixel in each of the subblocks 11 in the first group can be determined uniquely based on the data 28 of 18 bits. It should be noted that all of the four pixels included in each subblock 12 in the second group are supposed to be OFF-state pixels.

By performing these processing steps, the two-dimensionally encoded data 26 shown in FIG. 2 is generated. It should be noted that the subblock arrangement 25 and the two-dimensionally encoded data 26 shown in FIG. 2 are just examples of encoded data.

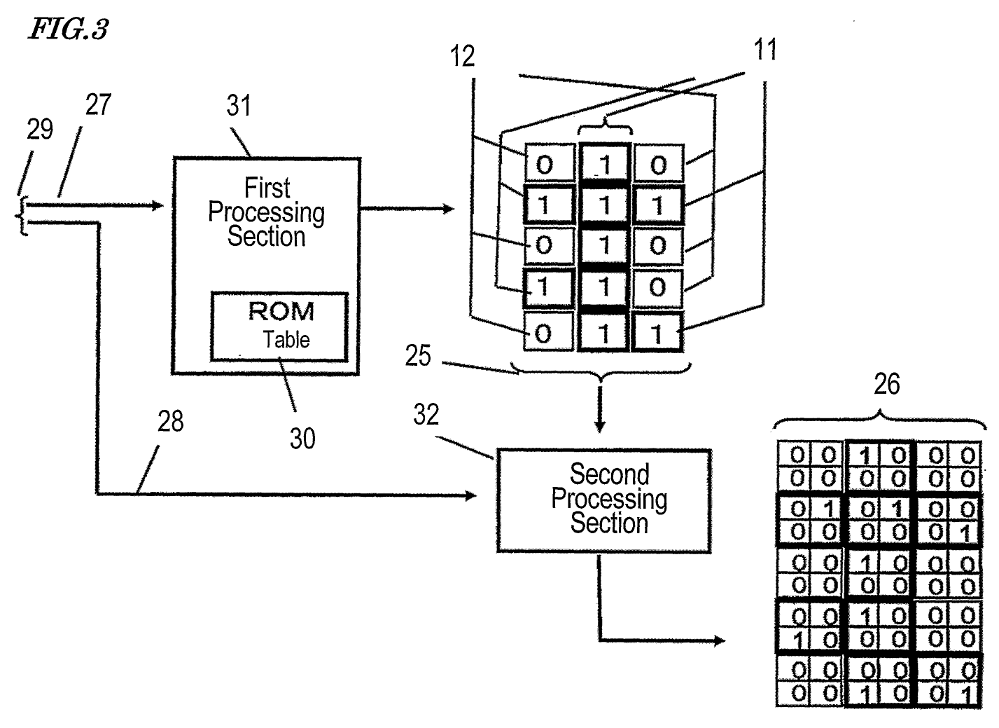

Next, a two-dimensional encoder according to this preferred embodiment will be described with reference to FIG. 3.

The two-dimensional encoder of this preferred embodiment receives data 29 of k (=30) bits, splits the data 29 into data 27 of k1 (=12) bits and data 28 of k2 (=18) bits, and then encodes them separately from each other (k=k1+k2).

This two-dimensional encoder includes a first processing section 31 for classifying a number n (=60) of pixels into a number s1 (=9) of subblocks 11 to form a first group and a number s2 (=6) of subblocks 12 to form a second group using the data 27 of k1 (=12) bits.

The two-dimensional encoder further includes a second processing section 32 for turning ON a number p(=1) of pixels out of the m(=4) pixels included in each subblock 11 in the first group and turning OFF all of the m(=4) pixels included in each subblock 12 in the second group using the data 28 of k2 (=18) bits.

In the two-dimensional encoder with such a configuration, first, the first processing section 31 determines the arrangement of the first and second groups of subblocks 11 and 12 using the data 27 of 12 bits. The arrangement of the 15 subblocks combined can be determined based on the data 27 of 12 bits by using a ROM table 30 of 4 kilowords (=12 bits×15 bits). As described above, a decoding table for use in the decoding operation has a size of 32 kilowords, whereas an encoding table has a size of 4 kilowords. In general, an encoding table can be implemented in a smaller circuit size than a decoding table.

The second processing section 32 determines the locations of the ON-state pixels in the respective subblocks 11 in the first group using the data 28 of 18 bits. In each subblock 11 in the first group, only one of the four pixels is an ON-state pixel. That is why the only ON-state pixel has four possible locations. Since 2² bits=4, data of 2 bits can be represented by a single subblock 11 in the first group. Consequently, the nine subblocks 11 in the first group can represent data of 18 bits (=2 bits×9) overall. Consequently, the location of the ON-state pixel in each of the nine subblocks 11 in the first group can be determined uniquely based on the data 28 of 18 bits. The location of the ON-state pixel in the four pixels may be determined using either a ROM table of 2 bits×4 bits or any other simple logic circuit.

In this preferred embodiment, the arrangement of the first and second groups of subblocks 11 and 12 is determined first, and then the location of the ON-state pixel in each subblock 11 in the first group is determined. However, these arrangements may be determined in reverse order, too.

As described above, the two-dimensional code of this preferred embodiment consists of a first group of subblocks 11, each including an ON-state pixel, and a second group of subblocks 12, each including no ON-state pixels, thereby reducing the ON rate with the increase in the sizes of encoding and decoding circuits minimized.

In the preferred embodiment described above, each subblock consisting of four pixels has a two-dimensional arrangement of 2×2 pixels. However, the four pixels may also have a one-dimensional arrangement of 1×4 pixels. Also, in the preferred embodiment described above, an item of two-dimensionally encoded data consists of a number n (=6×10=60) pixels. However, the two-dimensionally encoded data may also consist of any other combination of pixels (e.g., 4×15=60 pixels). And the number n of pixels of each item of two-dimensionally encoded data does not have to be 60, either.

Furthermore, in the preferred embodiment described above, the number s1 of subblocks in the first group and the number s2 of subblocks in the second group, which are included in a single item of encoded data, are supposed to be nine and six, respectively. However, s1 and s2 may also be other numbers as well.

Hereinafter, the coding rate and the ON rate in a situation where s1=7 and s2=4 will be estimated.

First, the total number of combinations of arrangements of these subblocks is Combination (1, 7)=330. Since 2⁸ bits=256, data of 8 bits can be represented by these combinations of arrangements of the first and second groups of subblocks 11 and 12.

In each subblock 11 in the first group, just one of the four pixels is an ON-state pixel. That is why the only ON-state pixel has four possible locations. Since 2² bits=4, data of 2 bits can be represented by a single subblock 11 in the first group. Consequently, the seven subblocks 11 in the first group can represent data of 14 bits (=2 bits×7) overall. Consequently, data of k bits (=8 bits+14 bits=22 bits) can be represented when the number of combinations of arrangements of the subblocks and the number of possible locations of the ON-state pixels are combined.

In this case, since the total number n of pixels is 4×11=44, the coding rate (k/n) is 22/44=0.5. Also, since the number of the subblocks 11 in the first group, in each of which only one of the four pixels is an ON-state pixel, is seven, the ON rate ((s1×p)/n) is 7/44=0.159. Also, the size of the decoding table is 2¹¹×8 bits=2 KB. Consequently, a low ON rate is realized in a small circuit size.

In the same way, a single item of two-dimensionally encoded data may also consist of eight subblocks forming a first group and five subblocks forming a second group (i.e., s1=8 and s2=5). Alternatively, a single item of two-dimensionally encoded data may also consist of ten subblocks forming a first group and seven subblocks forming a second group (i.e., s1=10 and s2=7). The coding rate does not have to be 0.5, either.

### Embodiment 2

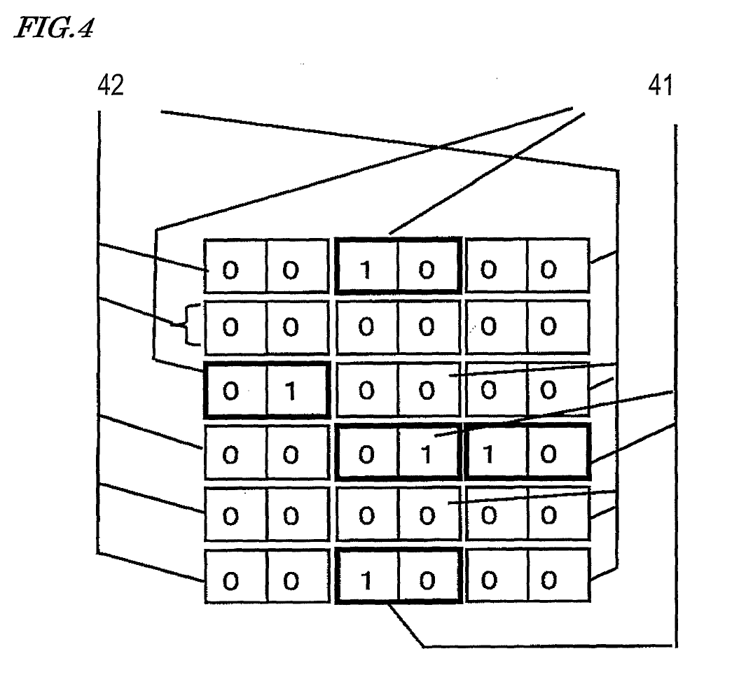

FIG. 4 shows another exemplary pixel pattern for two-dimensionally encoded data according to a second preferred embodiment of the present invention. In the two-dimensionally encoded data shown in FIG. 4, each subblock consists of two pixels (i.e., m=2). In the example shown in FIG. 4, a single two-dimensional code consists of five subblocks 41 forming a first group and thirteen subblocks 42 forming a second group (i.e., s1=5 and s2=13) and the total number n of pixels thereof is m×(s1+s2)=2×(5+13)=36.

In each subblock 41 in the first group, only one of the two pixels thereof is an ON-state pixel. On the other hand, in each subblock 42 in the second group, both of the two pixels thereof are OFF-state pixels.

The total number of arrangements of the five subblocks 41 in the first group and the thirteen subblocks 42 in the second group is Combination (18, 5)=8,568. Since 2¹³ bits=8,192, data of 13 bits can be represented by the combinations of arrangements of the first and second groups of subblocks 41 and 42.

On the other hand, in each subblock 41 in the first group, just one of the two pixels is an ON-state pixel. That is why the only ON-state pixel has two possible locations. Since 2¹ bits=2, data of 1 bit can be represented by a single subblock 41 in the first group. Consequently, the five subblocks 41 in the first group can represent data of 5 bits (=1 bit×5) overall.

The two-dimensionally encoded data shown in FIG. 4 can represent data of 13 bits by combining the arrangements of the subblocks 41, 42 in the first and second groups and can also represent data of 5 bits by the locations of the ON-state pixels in the respective subblocks 41 in the first group. Consequently, data of 18 bits (k=13 bits+5 bits) can be represented. And since the total number n of pixels is 36 in this example, the coding rate (k/n) is 18/36=0.5. Also, since the number of the subblocks 41 in the first group, in each of which only one of the two pixels is an ON-state pixel, is five, the ON rate is 5/36=0.139.

A conversion table required in performing encoding and decoding operations on the two-dimensional code of this preferred embodiment is a table for converting 18 bits into 13 bits, or vice versa, i.e., to carry out conversion between combinations of arrangements of the 18 subblocks 41 and 42 in the first and second groups and the data of 13 bits. The decoding table has a size of 2¹⁸×13 bits=256 kilowords. Furthermore, to decode the location of the ON-state pixel in each subblock 41 in the first group, a decoding table of 2 bits×1 bit is needed.

A decoding operation with the decoding table of 2 bits×1 bit may be carried out by either using a single table five times or preparing five tables and using them in parallel with each other. In any case, the size of the table for performing these decoding operations is much smaller than that of the decoding table that is 256 kilowords. Consequently, the conversion (decoding) is realized by using a ROM table with a circuit size that is approximately equal to 256 kilowords.

On the other hand, according to a conventional code in which three out of twenty pixels are turned ON, the ON rate thereof is 0.15 and the conversion needs to be performed using a conversion table between 10 bits and 20 bits. Among other things, the size of the decoding table is 2²⁰×10 bits=1 megaword, thus requiring a ROM table with a huge storage capacity. Consequently, by using the two-dimensional code of this preferred embodiment, decoding can be done using a decoding table of a smaller size and the ON rate can also be reduced to 0.139.

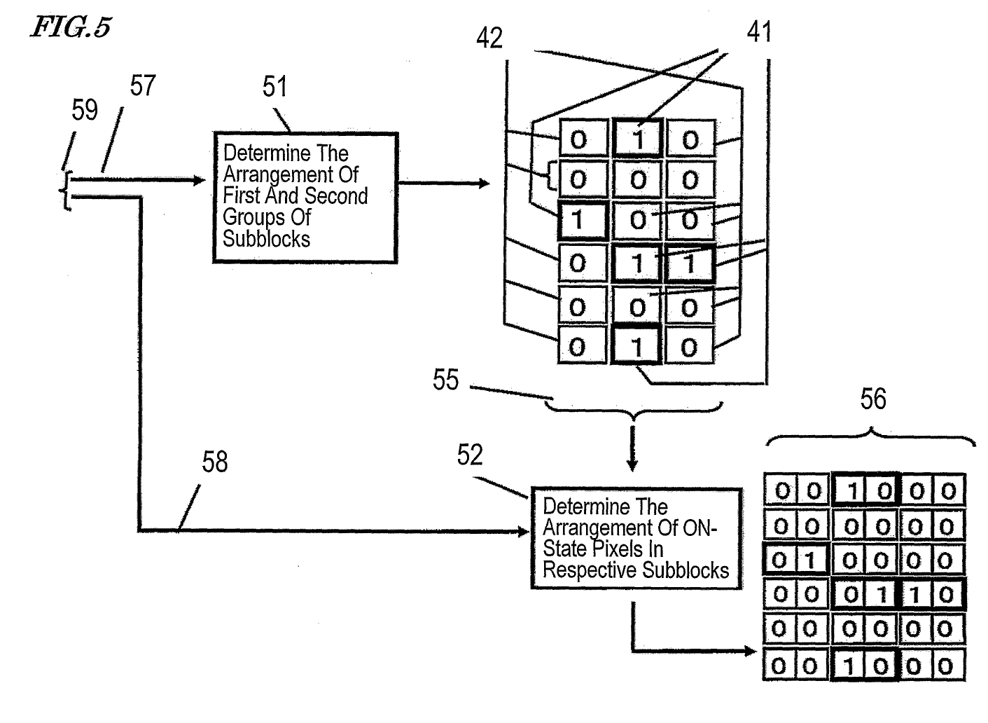

Next, a method for generating the two-dimensionally encoded data shown in FIG. 4 will be described with reference to FIG. 5.

First, the arrangement of the first and second groups of subblocks 41 and 42 is determined in Step S51 and then the arrangement of the ON-state pixels in the respective subblocks 41, 42 is determined in Step S52. Specifically, in this preferred embodiment, data 59 of k (=18) bits is split into data 57 of k1 (=13) bits and data 58 of k2 (=5) bits, which are then encoded separately from each other.

More specifically, first, using the data 57 of 13 bits, the arrangement of the first and second groups of subblocks is determined in Step S51. FIG. 5 shows an example of subblock arrangement 55 that has been determined in this manner.

The total number of combinations of arrangements of the five subblocks 41 in the first group and the thirteen subblocks 42 in the second group is Combination (18, 5)=8,568. Since 2¹³ bits=8,192, data 57 of 13 bits can be encoded uniquely into an arrangement of the subblocks 41, 42 by defining in advance 8,192 different combinations of arrangements of the first and second groups of subblocks 41 and 42 out of the 8,568 combinations.

Next, in Step S52, using the data 58 of 5 bits, the locations of the ON-state pixels in the respective subblocks 41 in the first group are determined. Data of 1 bit can be represented by a single subblock 41 in the first group. Consequently, the five subblocks 41 in the first group can represent data of 5 bits (=1 bit×5) overall. Consequently, the location of the ON-state pixel in each of the subblocks 41 in the first group can be determined uniquely based on the data 58 of 5 bits. It should be noted that both of the two pixels included in each subblock 42 in the second group are supposed to be OFF-state pixels.

By performing these processing steps, the two-dimensionally encoded data 56 is generated. It should be noted that the subblock arrangement 55 and the two-dimensionally encoded data 56 shown in FIG. 5 are just examples of encoded data.

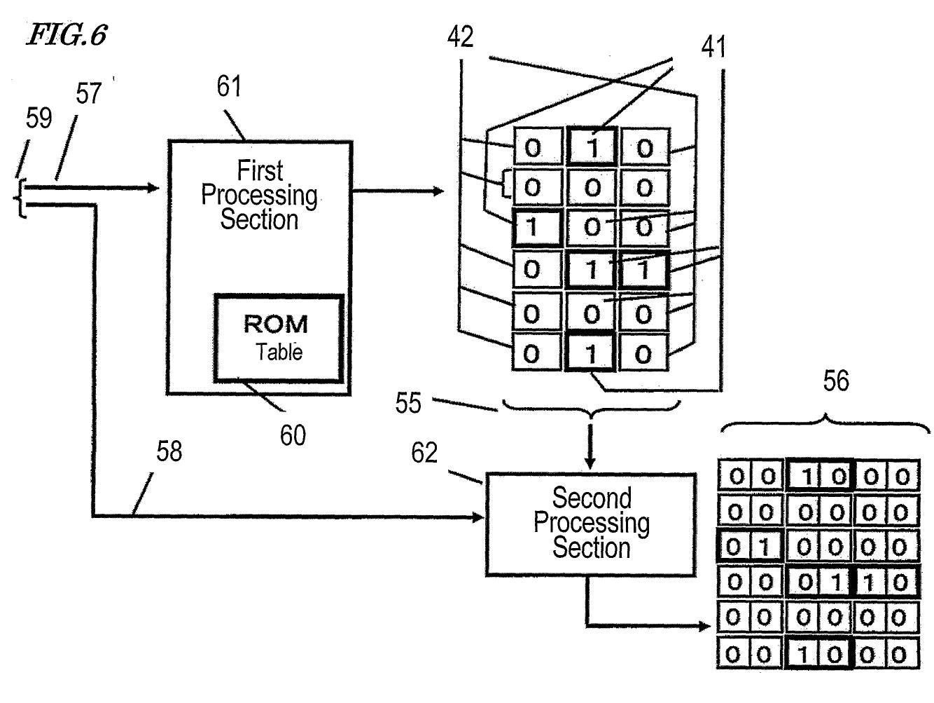

Next, a two-dimensional encoder according to this preferred embodiment will be described with reference to FIG. 6.

The two-dimensional encoder of this preferred embodiment includes a first processing section 61 for determining the arrangement of the first and second groups of subblocks 41 and a second processing section 62 for determining the locations of the ON-state pixels in the respective subblocks 41 in the first group.

The first processing section 61 determines the arrangement of the first and second groups of subblocks 41 and 42 using the data 57 of 13 bits. The arrangement of the 18 subblocks combined can be determined based on the data 57 of 13 bits by using a ROM table 30 of 8 kilowords (=13 bits×18 bits). As described above, a decoding table for use in the decoding operation has a size of 256 kilowords, whereas an encoding table has a size of 8 kilowords. In general, an encoding table can be implemented in a smaller circuit size than a decoding table.

Next, the second processing section 62 determines the locations of the ON-state pixels in the respective subblocks 41 in the first group using the data 58 of 5 bits. In the respective subblocks 41 and 42, the location of the ON-state pixel in the two pixels may be determined with respect to data of 1 bit using either a ROM table of 1 bit×2 bits or any other simple logic circuit.

In this preferred embodiment, the arrangement of the first and second groups of subblocks 41 and 42 is determined first, and then the location of the ON-state pixel in each subblock 41 in the first group is determined. However, these arrangements may be determined in reverse order, too. In either case, the two-dimensionally encoded data 56 shown in FIG. 6 is generated.

As described above, the two-dimensional code of this preferred embodiment consists of five subblocks 41 forming a first group and thirteen subblocks 42 forming a second group, thereby reducing the ON rate with the increase in the sizes of encoding and decoding circuits minimized.

In this preferred embodiment, each subblock consisting of two pixels has a horizontally extended arrangement of 1×2 pixels. Alternatively, the two pixels may also have a vertically extended arrangement of 2×1 pixels. Also, the two-dimensionally encoded data of this preferred embodiment has an arrangement of 6×6 pixels. But any other two-dimensional arrangement such as an arrangement of 12×3 pixels may also be adopted.

Furthermore, the two-dimensional code of the preferred embodiment described above consists of five subblocks 41, forming a first group and each including two pixels, and thirteen subblocks 42 forming a second group and each also including two pixels. However, various other combinations may also be adopted as well. For example, the two-dimensional code may also consist of four subblocks 41 forming a first group and nine subblocks 42 forming a second group. In that case, the total number of combinations of arrangements of these subblocks 41 and 42 is Combination (13, 4)=715. Since 2⁹ bits=512, data of 9 bits can be represented by these combinations of arrangements of the first and second groups of subblocks 41 and 42.

In each subblock 41 in the first group, just one of the two pixels is an ON-state pixel. That is why the only ON-state pixel has two possible locations. Since 2¹ bit=2, data of 1 bit can be represented by a single subblock 41 in the first group. Consequently, the four subblocks 41 in the first group can represent data of 4 bits (=1 bit×4) overall. Consequently, data of k bits (=9 bits+4 bits=13 bits) can be represented when the number of combinations of arrangements of the subblocks 41 and 42 and the number of possible locations of the ON-state pixels are combined. In this case, since the total number n of pixels is 2×13=26, the coding rate (k/n) is 13/26=0.5. Also, since the number of the subblocks 41 in the first group, in each of which only one of the two pixels is an ON-state pixel, is four, the ON rate is 4/26=0.154.

In this case, the size of the decoding table is 2¹³×9 bits=8 kilowords. Consequently, a low ON rate is realized in a small circuit size.

In the same way, a single item of two-dimensionally encoded data may also consist of five subblocks 41 forming a first group and twelve subblocks 42 forming a second group. Alternatively, a single item of two-dimensionally encoded data may also consist of six subblocks forming a first group and fourteen subblocks forming a second group.

The coding rate does not have to be 0.5, either. Various two-dimensional codes with mutually different coding rates can be formed by appropriately selecting the number of pixels in each subblock and/or the number of subblocks included in the first or second group.

In the preferred embodiments described above, m=2 or m=4. However, the present invention is also applicable to even a situation where m=16. Although p=1 when m=2 or m=4, p is preferably equal to three when m=16. If m=16, s1 and s2 may be 3 and 1, respectively.

### Embodiment 3

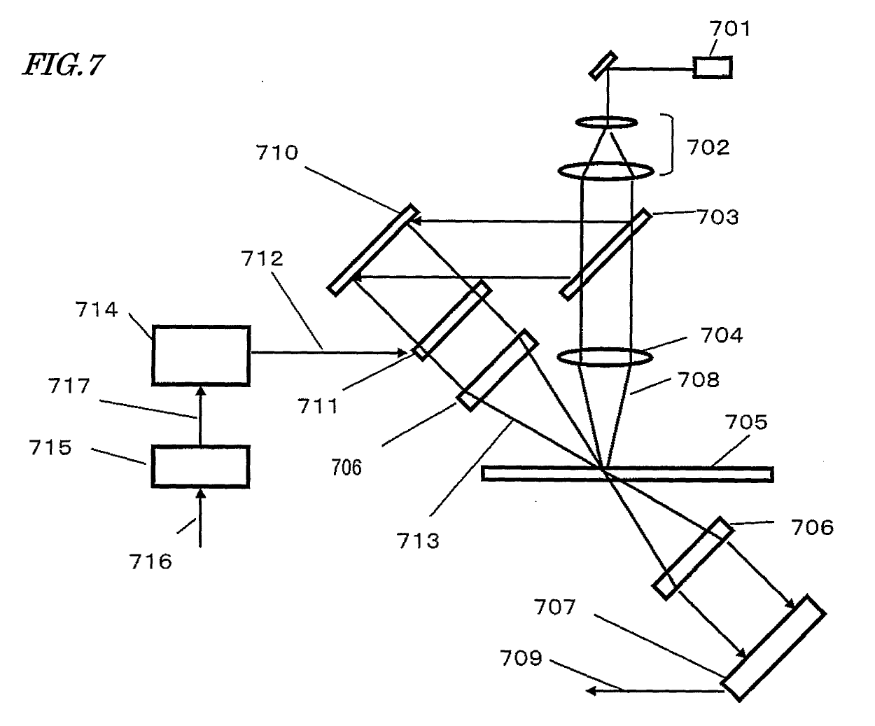

Hereinafter, a preferred embodiment of a holographic memory device according to the present invention will be described with reference to FIG. 7, which is a block diagram illustrating a schematic configuration for a holographic memory device according to a third preferred embodiment of the present invention.

The holographic memory device of this preferred embodiment is mainly characterized by including a two-dimensional encoder according to the present invention. Therefore, the other components of the holographic memory device may be replaced with various elements or components of a known holographic memory device. In this description, the “holographic memory device” broadly refers to any device with at least one of read and write functions. That is to say, a read/write device, a read-only device and a write-only device are all encompassed in the “holographic memory devices”.

The holographic memory device shown in FIG. 7 includes: a laser beam source 701 for emitting a light beam as either a write light beam (including an optical signal beam and a reference beam) or read light beam; a beam expander 702 for expanding the diameter of the light beam; a half mirror 703 for splitting the light beam into two light beams; and a condenser lens 704 for condensing one of the two light beams (i.e., the reference beam) that have been produced by the half mirror 703 on a holographic memory medium 705.

The holographic memory device further includes: a mirror 710 for reflecting the other light beam (i.e., the optical signal beam) that has been produced by the half mirror 703; a spatial light modulator 711 for adding a two-dimensional code to the optical signal beam; and a Fourier transform lens 706 for condensing the optical signal beam, transmitted through the spatial light modulator 711, onto the holographic memory medium 705.

The holographic memory device further includes: a two-dimensional encoder 714 for driving the spatial light modulator 711 based on write data 717; and an error correction coder 715 for adding an error correction code to data 716, thereby generating the write data 717. Also, to perform a read function, the holographic memory device further includes a photodetector 707 and another Fourier transform lens 706 for focusing the diffracted light, which has come from the holographic memory medium 705, on the photodetector 707.

In the holographic memory device of this preferred embodiment with such a configuration, the light beam emitted from the laser beam source 701 has its beam diameter expanded by the beam expander 702 and then is split by the half mirror 703 into two light beams. One of the two split light beams has its traveling directions changed by the mirror 710 to be incident on the spatial light modulator 711. The spatial light modulator 711 may be implemented as a liquid crystal cell, for example, and includes a plurality of pixels that are arranged two-dimensionally. These pixels can transmit and cut off the incoming light independently of each other. Thus, an arbitrary arrangement pattern of ON- and OFF-state pixels can be represented by the two-dimensionally encoded data 712 that has been supplied from the two-dimensional encoder 714. A single spatial light modulator 711 may have one million pixels, for example.

The beam that has been transmitted through the spatial light modulator 711 is condensed by the Fourier transform lens 706 to irradiate a predetermined portion of the holographic memory medium 705 with an optical signal beam 713. The two-dimensional pattern of the ON- and OFF-state pixels that has been presented on the spatial light modulator 711 is subjected to a Fourier transform by the Fourier transform lens 706. Consequently, a Fourier transformed image of the two-dimensional ON/OFF pattern on the spatial light modulator 711 is formed on the holographic memory medium 705.

The other one of the two split light beams produced by the half mirror 703 is condensed by the condenser lens 704 to irradiate the predetermined portion of the holographic memory medium 705 with reference beam 708. The portion of the holographic memory medium 705 irradiated with the reference beam 708 and the portion irradiated with the optical signal beam 713 are located in the same area.

The holographic memory medium 705 is made of a hologram material such as a photopolymer. When irradiated with the optical signal beam 713 and the reference beam 708 at the same time, the holographic memory medium 705 produces interference fringes and records them thereon. If the spatial light modulator 711 modulates the light spatially according to a pixel pattern corresponding to the arrangement 26 shown in FIG. 3, for example, the two-dimensionally encoded data can be written on the holographic memory medium 705.

To detect errors occurring on the holographic memory medium 705, the data 716 is subjected to error correction coding according to this preferred embodiment by the error correction coder 715 using a Reed-Solomon code or a low density parity check code (LDPC) to output it as write data 717. After the two-dimensional encoder 714 has generated predetermined two-dimensionally encoded data 712, the write data 717 will be output to the spatial light modulator 711. The two-dimensional encoder 715 may have the same configuration as the counterpart of the first or second preferred embodiment shown in FIG. 3 or 6.

In the holographic memory device of this preferred embodiment, the two-dimensional encoder 714 performs two-dimensional encoding during the write operation to generate two-dimensionally encoded data in which the n pixels are classified into a number s1 of subblocks forming a first group, where only one of m pixels is turned ON, and a number s2 of subblocks forming a second group, in which all of m pixels are turned OFF, so as to satisfy m×(s1+s2)=n. By reducing the ON rate in this manner with the increase in the sizes of circuits for encoding and decoding minimized, the read errors can be cut down.

The write data 717 is equivalent to either the data 29 shown in FIG. 3 or the data 59 shown in FIG. 6. The two-dimensionally encoded data 712 corresponds to the two-dimensionally encoded data 26 or 56 shown in FIG. 3 or 6.

To get the written signal read by the holographic memory device shown in FIG. 7, the holographic memory medium 705 is irradiated with only the reference beam 708. Responsive to the reference beam 708, the interference fringes, stored in the holographic memory medium 705, produce diffracted light. This diffracted light passes through the Fourier transform lens 706 to be transformed into a two-dimensional train of light beams, which is then restored two-dimensionally on the photodetector 707 such as an array of CCDs, for example. By subjecting this train of light beams to a photoelectric conversion, a read signal 709 can be obtained. And by determining the ON and OFF states of the bit pattern of the resultant reproduced image, data can be read.

In this preferred embodiment, the two-dimensional code can be easily decoded by using a decoding table, from which data can be read as a combination of arrangements of the subblocks in the first and second groups, and another decoding table for detecting the location of the ON-state pixel in each subblock in the first group.

The holographic memory device of the preferred embodiment described above is supposed to be a device with both read and write functions. However, the present invention is also applicable to a device with only write function or a device with only read function.

### Embodiment 4

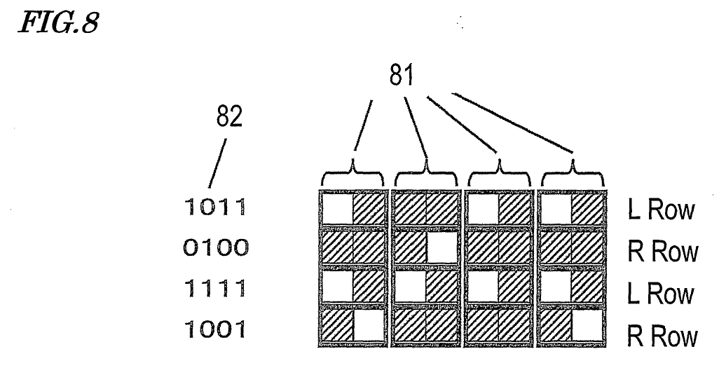

FIG. 8 shows another exemplary pixel pattern for two-dimensionally encoded data according to a fourth preferred embodiment of the present invention.

In FIG. 8, a number of subblocks 81, each consisting of two pixels, are arranged in columns and rows. In the example shown in FIG. 8, each row consists of four subblocks. FIG. 8 also shows exemplary write data 82 “1011010011111001” in four columns and fours rows.

In each of these subblocks 81, the open square represents an ON-state pixel while the shadowed square represents an OFF-state pixel. The ON-state pixel is a pixel that transmits light on a spatial light modulator, while the OFF-state pixel is a pixel that cuts off the light on the spatial light modulator.

In the two-dimensionally encoded data of this preferred embodiment, each of these subblocks 81 consists of two pixels, which are arranged in the same order in the row direction. That is to say, in the respective subblocks, the first pixel (shown on the left-hand side of FIG. 8) and the second pixel (shown on the right-hand side of FIG. 8) are arranged in this order in the row direction.

These subblocks are classified into subblocks 81 with an ON-state pixel (i.e., a first group of subblocks) and subblocks 81 with no ON-state pixel (i.e., a second group of subblocks). A subblock 81 with an ON-state pixel represents “1” and a subblock 81 with no ON-state pixel represents “0”.

In each row of the two-dimensionally encoded data of this preferred embodiment, either the right one or the left one of the two pixels of each subblock 81 with an ON-state pixel is the ON-state pixel. For example, in the first row, only the left pixel is the ON-state pixel. In the second row, only the right pixel is the ON-state pixel. A row in which only the left pixel is the ON-state pixel will be referred to herein as an “L row”, while a row in which only the right pixel is the ON-state pixel will be referred to herein as an “R row”. In this preferred embodiment, the odd-numbered rows are L rows, the even-numbered rows are R rows, and the L and R rows are alternately arranged perpendicularly to these rows (i.e., in the column direction).

Also, in this preferred embodiment, one bit of the write data 82 is represented by one subblock 81. Specifically, if a bit of the write data 82 is one, its associated subblock is turned ON. On the other hand, if another bit of the write data 82 is zero, its associated subblock is turned OFF.

As shown in FIG. 8, each row consists of four subblocks. Therefore, if the write data 82 is “1011010011111001”, the subblocks 81 on the first row are in ON, OFF, ON and ON states to represent the first row portion “1011” of the write data 82. In the same way, the subblocks 81 on the second row are in OFF, ON, OFF and OFF states to represent the second row portion “0100” of the write data 82. The subblocks 81 on the third row are in ON, ON, ON and ON states to represent the third row portion “1111” of the write data 82. And the subblocks 81 on the fourth row are in ON, OFF, OFF and ON states to represent the fourth row portion “1001” of the write data 82.

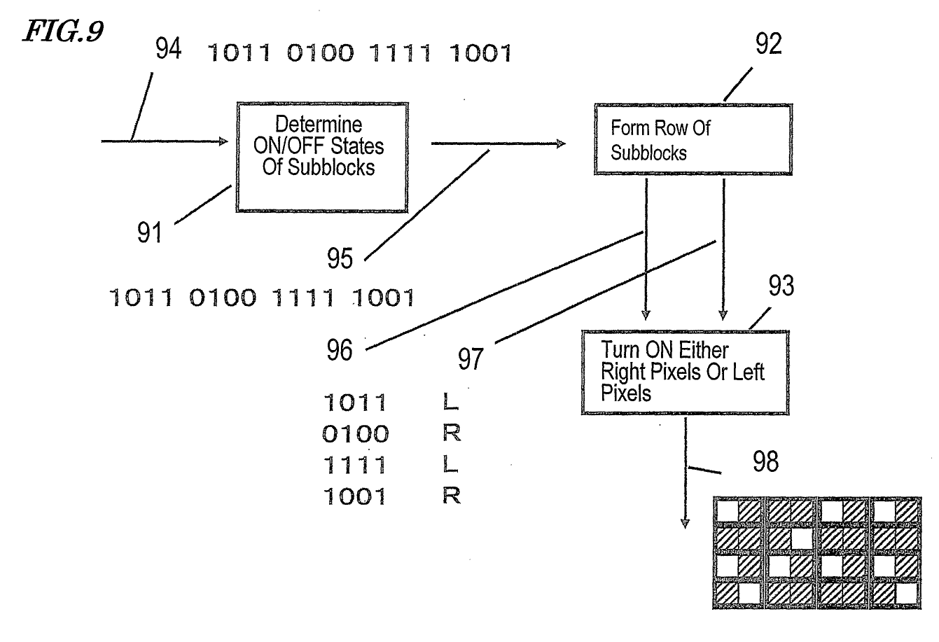

Hereinafter, a method for generating the two-dimensionally encoded data of this preferred embodiment will be described with reference to FIG. 9.

In this preferred embodiment, the ON and OFF states of respective subblocks are determined in Step 91 and the subblocks are arranged to form a number of rows in Step 92. Next, in Step 93, either the right pixel(s) or the left pixel(s) are turned ON depending on whether the given row is odd-numbered or even-numbered.

Specifically, if write data 94 is “1011010011111001”, for example, each bit of the write data 94 is associated with a single subblock in Step 91. More specifically, if a bit of the write data 94 is one, then its associated subblock is turned ON (i.e., determined to be one). On the other hand, if another bit of the write data 94 is zero, then its associated subblock is turned OFF (i.e., determined to be zero). In this manner, a train 95 of ones (in ON state) and zeros (in OFF state) is obtained.

Next, in Step 92, the number of subblocks per row is determined to be four, for example, the subblocks are arranged into a number of rows, each being a train 96 of ones (in ON state) and zeros (in OFF state), and then those rows of subblocks are subjected to the processing step 93 of turning ON either the right pixel or the left pixel in each subblock. At the same time, LR specifying information 97 is also provided such that L and R rows alternate each other.

In the processing step 93 of turning ON either the right pixel or the left pixel in each subblock, the left pixels of ON-state subblocks are turned ON for L rows and the right pixels of ON-state subblocks are turned ON for R rows based on the train 96 of ones (in ON state) and zeros (in OFF state) and the LR specifying information 97. As a result, two-dimensionally encoded data 98 is generated.

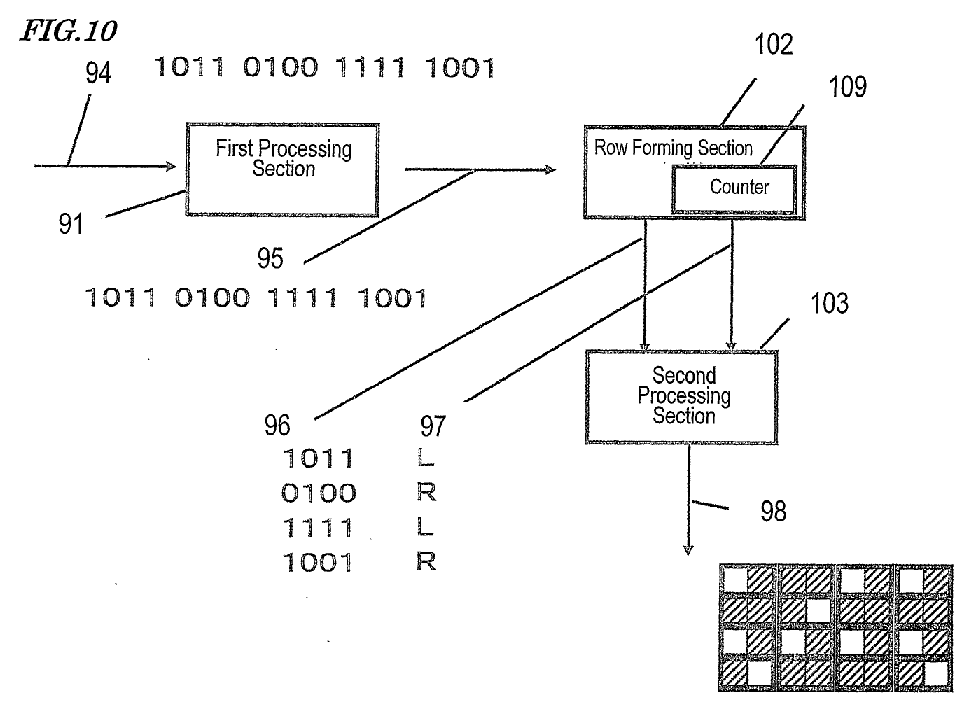

Hereinafter, a two-dimensional encoder according to this preferred embodiment will be described with reference to FIG. 10.

The two-dimensional encoder of this preferred embodiment includes a first processing section 101 for determining, based on write data, the ON and OFF states of subblocks, a row forming section 102 for arranging the subblocks as a number of rows, and a second processing section 103 for turning ON one of the first and second pixels in each of the subblocks that have been determined to turn ON among the subblocks,

In this preferred embodiment, if the subblock that has been determined to turn ON belongs to an odd-numbered row, the second processing section 103 turns ON the first pixel of the subblock. On the other hand, if the subblock that has been determined to turn ON belongs to an even-numbered row, the second processing section 103 turns ON the second pixel of the subblock.

In the two-dimensional encoder with such a configuration, if write data 94 is “1011010011111001”, for example, the first processing section 101 associates each bit of the write data 94 with a single subblock one to one. More specifically, if a bit of the write data 94 is one, then the first processing section 101 turns ON its associated subblock (i.e., determines it to be one). On the other hand, if another bit of the write data 94 is zero, then the first processing section 101 turns OFF its associated subblock (i.e., determines it to be zero). A train 95 of ones (in ON state) and zeros (in OFF state) that has been defined in this manner on a subblock-by-subblock basis is output to the row forming section 102 that arranges the subblocks as a number of rows.

The row forming section 102 determines the number of subblocks per row to be four, for example, arranges the subblocks as a number of rows, each being a train 96 of ones (in ON state) and zeros (in OFF state), and then outputs those rows of subblocks to the second processing section 103. At the same time, the row forming section 102 also provides LR specifying information 97 such that L and R rows alternate each other. The row forming section 102 may include a counter 109 for counting the number of subblocks per row.

The second processing section 103 turns ON the left pixels of ON-state subblocks for L rows and also turn ON the right pixels of ON-state subblocks for R rows based on the train 96 of ones (in ON state) and zeros (in OFF state) and the LR specifying information 97. The second processing section 103 may be implemented as a simple logic circuit. In this manner, two-dimensionally encoded data 98 is generated.

As described above, the two-dimensional encoder of this preferred embodiment turns ON the left pixels of ON-state subblocks 81 for L rows and also turn ON the right pixels of ON-state subblocks 81 for R rows. That is why the ON-state pixels are never adjacent to each other either vertically or horizontally. With no adjacent ON-state pixels present, the interference between the pixels can be reduced and the read errors can be cut down.

In this preferred embodiment, one row consists of four subblocks, or eight pixels. However, one row may actually consist of much more pixels. Each row could be made up of several hundreds to several thousands of pixels. And the number of rows could also be in the range of several hundreds to several thousands.

Also, in the preferred embodiment described above, if a bit of write data is one, its associated subblock is turned ON. On the other hand, if a bit of write data is zero, its associated subblock is turned OFF. Conversely, a subblock may be turned OFF when its associated bit of write data is one and may be turned ON when its associated bit of write data is zero. Optionally, conversion may be performed between the write data and the subblocks following a predetermined conversion rule.

The effects of this preferred embodiment will also be achieved even if the row direction and the column direction are interchanged. The same statement will apply to a fifth preferred embodiment of the present invention to be described below.

### Embodiment 5

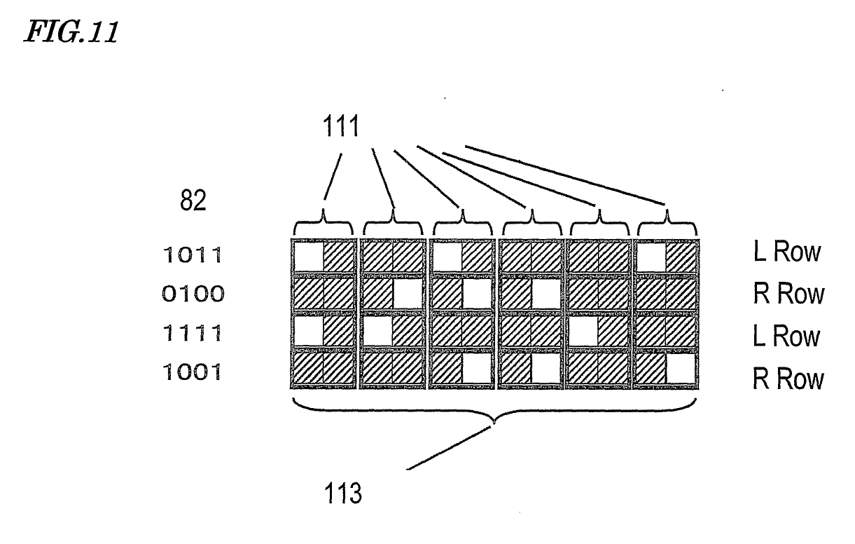

FIG. 11 shows another exemplary pixel pattern for two-dimensionally encoded data according to a fifth preferred embodiment of the present invention.

The two-dimensionally encoded data shown in FIG. 11 is made up of a number of subblocks 111, each consisting of two pixels, and its arrangement is basically similar to the two-dimensionally encoded data of the fourth preferred embodiment described above.

In this preferred embodiment, each row consists of six subblocks. And those six subblocks, included in each row of the two-dimensionally encoded data, is supposed to form a single block 113 according to this preferred embodiment. However, a single block 113 may also consist of any other number of subblocks, not just six.

Also, in this preferred embodiment, the number of ON-state pixels included is constant in each and every block 113. In the example shown in FIG. 11, three out of six subblocks 111 that form a single block 113 have been turned ON.

If the write data 82 is “1011 0100 1111 1011”, for example, the first row may consist of ON, OFF, ON, OFF, OFF and ON state subblocks. In the same way, the second row may consist of OFF, ON, ON, ON, OFF and OFF state subblocks. The third row may consist of ON, ON, OFF, OFF, ON and OFF state subblocks. And the fourth row may consist of OFF, OFF, ON, ON, OFF and ON state subblocks.

This conversion is just an example. Alternatively, three out of the six subblocks 111 may be turned ON using sixteen different types of write data 82, which can be represented by 4 bits. Since there are 20 different combinations when three subblocks are selected from six subblocks, the predetermined conversion rule may be defined arbitrarily by defining 16 appropriate combinations in advance.

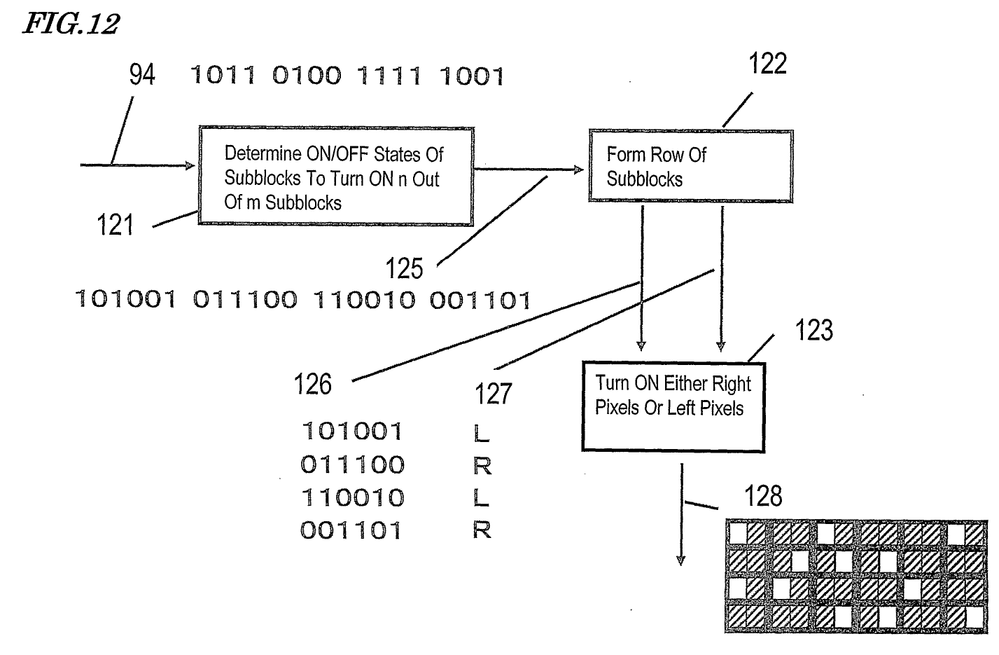

Hereinafter, a process for generating such two-dimensionally encoded data will be described with reference to FIG. 12.

In this preferred embodiment, the ON and OFF states of respective subblocks are determined in Step 121 such that n out of m subblocks are turned ON and the subblocks are arranged to form a number of rows in Step 122. Next, in Step 123, either the right pixel(s) or the left pixel(s) are turned ON.

Specifically, if write data 94 is “1011010011111001”, for example, the ON and OFF states of the respective subblocks are determined in Step 121 such that three out of six subblocks are turned ON every four bits of the write data 94 following a predetermined conversion rule. In this example, supposing the ON state is represented by one and the OFF state is represented by zero, the write data 94 is converted into a train 125 of ones (in ON state) and zeros (in OFF state) “101001 011100 110010 001101”.

Next, in Step 122, the number of subblocks per row is determined to be six, for example, the subblocks are arranged into a number of rows, each being a train 126 of ones (in ON state) and zeros (in OFF state), and then those rows of subblocks are output. At the same time, LR specifying information 127 is also provided such that L and R rows alternate each other.

In Step 123, the left pixels of ON-state subblocks are turned ON for L rows and the right pixels of ON-state subblocks are turned ON for R rows based on the train 126 of ones (in ON state) and zeros (in OFF state) and the LR specifying information 127. As a result, two-dimensionally encoded data 128 is generated.

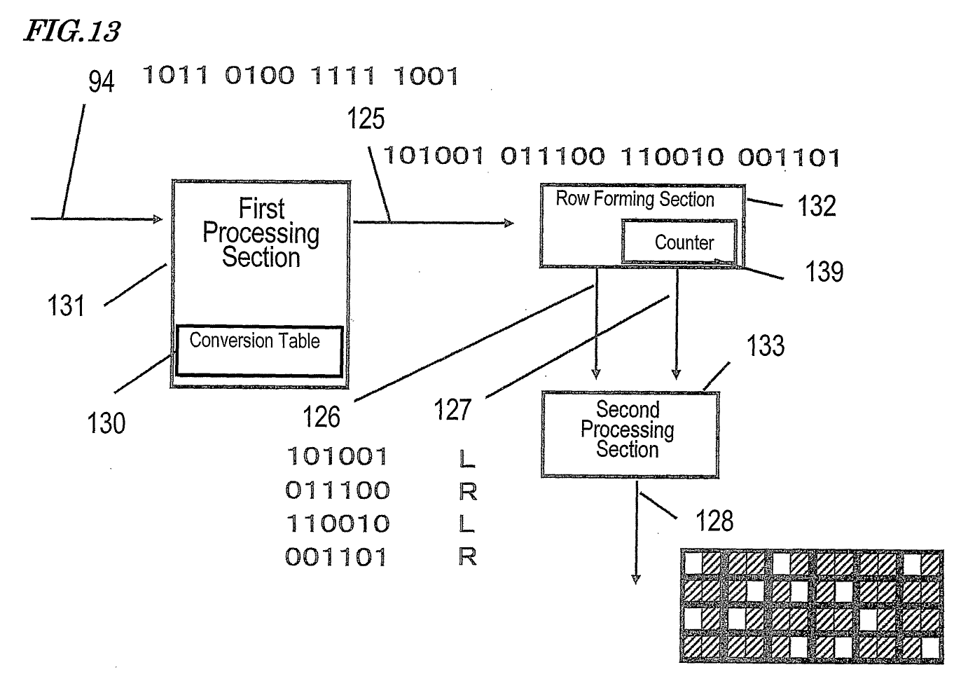

FIG. 13 is a block diagram of a two-dimensional encoder according to this preferred embodiment.

The two-dimensional encoder of this preferred embodiment includes a first processing section 131 for determining the ON and OFF states of respective subblocks such that n out of m subblocks are turned ON, a row forming section 132 for arranging the subblocks as a number of rows, and a second processing section 133 for turning ON either the right pixel(s) or the left pixel(s).

In this two-dimensional encoder, if write data 94 is “1011010011111001”, for example, the first processing section 131 determines the ON and OFF states of the respective subblocks such that three out of six subblocks are turned ON every four bits of the write data 94 following a predetermined conversion rule that is stored in a conversion table 130. In this example, supposing the ON state is represented by one and the OFF state is represented by zero, the write data 94 is converted into a train 125 of ones (in ON state) and zeros (in OFF state) “101001 011100 110010 001101” and output to the row forming section 132.

The row forming section 132 determines the number of subblocks per row to be six, for example, arranges the subblocks as a number of rows, each being a train 126 of ones (in ON state) and zeros (in OFF state), and then outputs those rows of subblocks and the LR specifying information 127 to the second processing section 133. The row forming section 132 may include a counter 139 for counting the number of subblocks per row.

The second processing section 133 turns ON the left pixels of ON-state subblocks for L rows and also turn ON the right pixels of ON-state subblocks for R rows based on the train 126 of ones (in ON state) and zeros (in OFF state) and the LR specifying information 127. The second processing section 133 may be implemented as a simple logic circuit. In this manner, two-dimensionally encoded data 128 is generated.

In the preferred embodiment described above, the L and R rows are arranged alternately, the left pixels of ON-state subblocks 111 are turned ON for L rows and the right pixels of ON-state subblocks 111 are turned ON for R rows. That is why the ON-state pixels are never adjacent to each other either vertically or horizontally. With no adjacent ON-state pixels present, the interference between the pixels can be reduced and the read errors can be cut down.

In addition, since the number of ON-state pixels per block is constant, pixels with the three highest luminances in a block may be detected as ON-state pixel locations without performing a slice level detection with respect to a reference level. As a result, relative detection of the pixels to read is realized and a read operation can be performed with more reliability and with an even smaller number of read errors.

In this preferred embodiment, one row consists of six subblocks, or twelve pixels. However, one row may actually consist of much more pixels. Also, the number of subblocks per row is preferably an integral multiple of the number of subblocks forming one block to simplify the processing.

Also, in the preferred embodiment described above, if a bit of write data is one, its associated subblock is turned ON. On the other hand, if a bit of write data is zero, its associated subblock is turned OFF. Conversely, a subblock may be turned OFF when its associated bit of write data is one and may be turned ON when its associated bit of write data is zero. Optionally, conversion may be performed between the write data and the subblocks following a predetermined conversion rule.

Instead of turning ON three out of six subblocks, four out of eight subblocks may be turned ON, for example. In that case, the number of combinations is 70, and therefore, write data of six bits can be processed.

Any other configuration may be defined arbitrarily to turn ON n out of m subblocks. Generally speaking, the bigger m or n, the better the coding rate, which is defined by the number of bits of write data and the number of cells that form one block, could be. Nevertheless, as the device would need a conversion table of an increased size in that case, an appropriate combination of m and n is preferably adopted.

Just like the two-dimensional encoder of the first or second preferred embodiment described above, the two-dimensional encoder of the fourth or fifth preferred embodiment may also be used effectively as the two-dimensional encoder 714 of the holographic memory device shown in FIG. 7.

### Embodiment 6

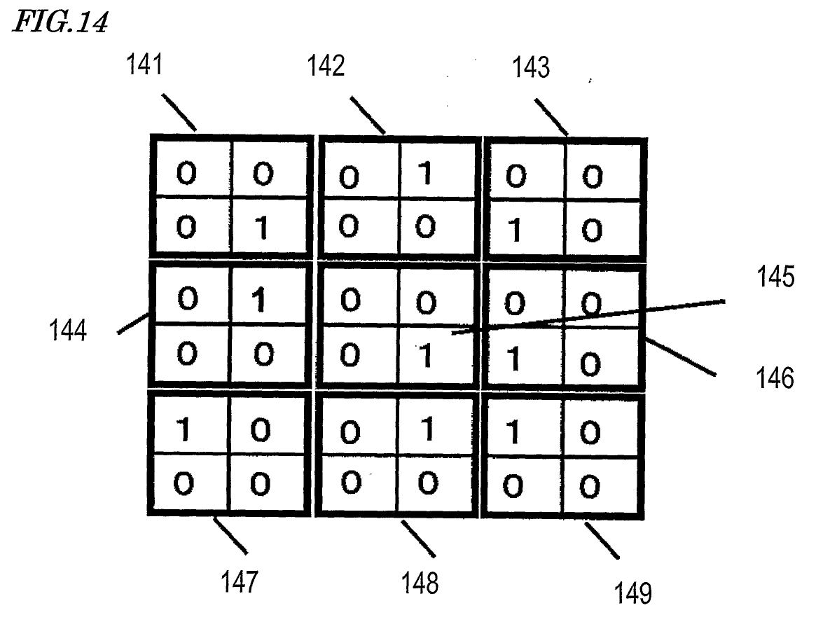

FIG. 14 shows yet another exemplary pixel pattern for two-dimensionally encoded data according to a sixth preferred embodiment of the present invention. In the two-dimensionally encoded data shown in FIG. 8, ON-state pixels are never adjacent to each other either vertically or horizontally in the arrangement of pixels. According to this preferred embodiment, even if ON-state pixels are adjacent to each other, read errors can also be reduced by adjusting the transmittances of those ON-state pixels on a spatial light modulator.

The two-dimensionally encoded data shown in FIG. 14 is an example of data that has been encoded two-dimensionally with the 2-4 code, and consists of nine subblocks 141 through 149, each being made up of 2×2 (=four) pixels.

The 2-4 code is used to convert two bits into four pixels. By turning ON only one of the four pixels, four different patterns are represented by the locations of the ON-state pixels. That is why the 2-4 code can represent data of two bits. In FIG. 14, ON-state pixels are represented by one and OFF-state pixels are represented by zero.

In the 2-4 code, only one out of four pixels is turned ON, and therefore, ON-state pixels may be adjacent to each other between adjacent code elements. In the arrangement of the subblocks 141 through 149, at most four ON-state pixels may be adjacent to each other.

Specifically, in the exemplary two-dimensionally encoded data shown in FIG. 14, two ON-state pixels are adjacent to each other between subblocks 141 and 144. Likewise, two ON-state pixels are adjacent to each other between subblocks 142 and 143.

Also, four ON-state pixels are adjacent to each other among four subblocks 145, 146, 148 and 149. Meanwhile, the ON-state pixel of a subblock 147 is surrounded with no adjacent ON-state pixels and is isolated.

As can be seen from this example, in the 2-4 code, ON-state pixels may be adjacent to each other according to the data and the number of ON-state pixels that can be adjacent to a single ON-state pixel is zero, one, two or three. For example, the isolated ON-state pixel of the subblock 147 has zero adjacent ON-state pixels. On the other hand, the ON-state pixel of each of the subblocks 145, 146, 148 and 149 has three adjacent ON-state pixels. Furthermore, the ON-state pixel in each of the subblocks 141, 144, 142 and 143 has one adjacent ON-state pixel.

The sixth preferred embodiment of the present invention is characterized in that when a pattern of ON- and OFF-state pixels is formed on the spatial light modulator of a holographic memory device based on two-dimensionally encoded data, the optical transmittance of each ON-state pixel is reduced according to the number of other ON-state pixels that are adjacent to that ON-state pixel.

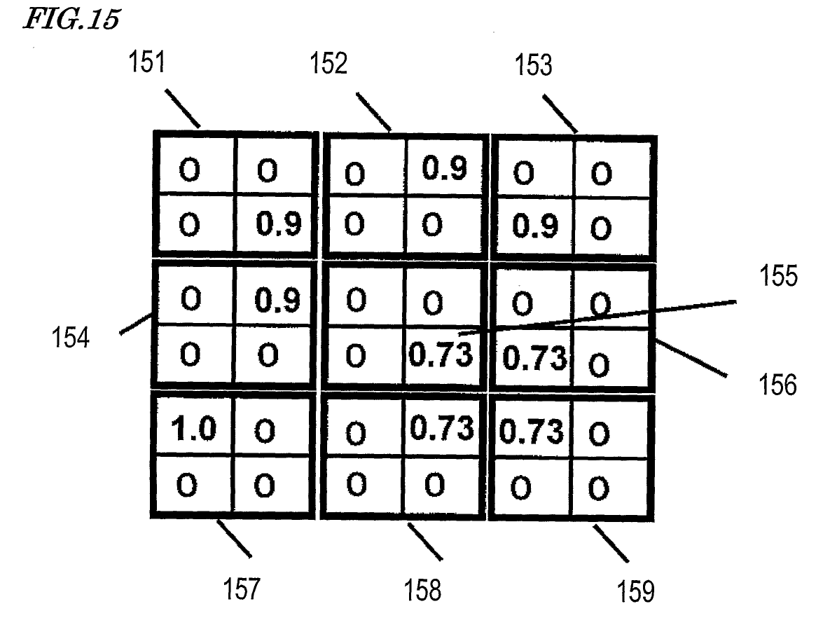

FIG. 15 shows exemplary transmittances of respective ON-state pixels of a spatial light modulator that have been determined based on the two-dimensionally encoded data shown in FIG. 14.

In FIG. 15, the subblocks 151 through 159 respectively correspond to the subblocks 141 through 149 shown in FIG. 14, and the numerical values represent the transmittances of respective pixels. In this example, the transmittance of the OFF-state pixels is supposed to be zero and the transmittance of each of the ON-state pixels is calculated by 1.0×(0.9)̂(the number of adjacent ON-state pixels), where ̂ represents a power.

The isolated ON-state pixel included in the subblock 157 has zero adjacent ON-state pixels, and therefore, has a transmittance of 1.0. Each of the subblocks 151, 152, 153 and 154 has one adjacent ON-state pixel and a transmittance of 0.9. And each of the subblocks 155, 156, 158 and 159 has three adjacent ON-state pixels, and a transmittance of 0.73.

The lower the transmittance, the lower the intensity of the light that irradiates the holographic memory medium. Since the OFF-state pixels have a transmittance of zero, the light is cut off by the OFF-state pixels.

In this preferred embodiment, the transmittance of each ON-state pixel is reduced according to the number of its adjacent ON-state pixels, thereby weakening the influence of intersymbol interference to be caused by leakage of light into adjacent pixels. The greater the number of adjacent ON-state pixels (i.e., the greater the influence of the intersymbol interference), the lower the transmittance of the spatial light modulator (i.e., the lower the intensity of the write light) is set to be. In this manner, the influence of the intersymbol interference can be weakened. And even if some ON-state pixels are adjacent to each other, read errors can still be reduced.

It should be noted that the transmittances of the respective pixels shown in FIG. 15 are just examples. Thus, it can be seen easily that transmittances may be other arbitrary values. Also, in the example described above, the number of adjacent ON-state pixels is counted in the eight vertically, horizontally and diagonally adjacent pixels. Alternatively, the number of adjacent ON-state pixels may also be counted in the four vertically and horizontally adjacent pixels. In that case, the processing load of counting the number of adjacent ON-state pixels can be lightened. Still alternatively, the range to count the number of adjacent ON-state pixels may be expanded as well. For example, the number of adjacent ON-state pixels may be counted in a total of 24 pixels consists of eight adjacent pixels and their surrounding pixels. Then, the transmittance can be defined more finely.

In this preferred embodiment, the 2-4 code has been described as an exemplary two-dimensional code. However, any other two-dimensional code may also be used. For example, a two-dimensional code in which three out of sixteen pixels are turned ON may also be used.

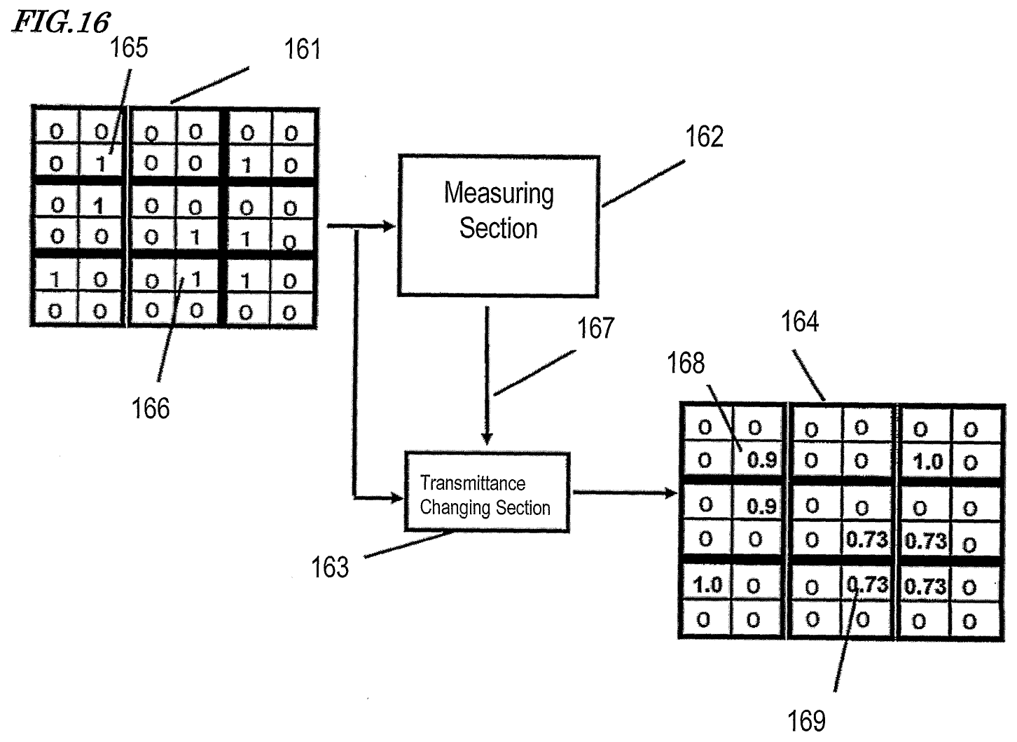

Next, a transmittance setter according to this preferred embodiment will be described with reference to FIG. 16.

Two-dimensionally encoded data 161 is supplied to a measuring section 162 for counting the number of ON-state pixels included in the pixels surrounding an ON-state pixel. Specifically, the measuring section 162 counts the number of ON-state pixels included in a total of eight pixels that are vertically, horizontally and diagonally adjacent to each ON-state pixel. For example, the ON-state pixel 165 that is located on the second column from the left and on the second row from the top of the two-dimensionally encoded data 161 has only one adjacent ON-state pixel. On the other hand, the ON-state pixel 166 that is located on the fourth column from the left and on the fifth row from the top of the two-dimensionally encoded data 161 has three adjacent ON-state pixels.

The measuring section 162 performs the calculation described above on every ON-state pixel and counts the number of ON-state pixels surrounding each ON-state pixel. The count is supplied to a transmittance changing section 163.

The transmittance changing section 163 generates transmittance setting data 164 based on the two-dimensionally encoded data 161 and the count 167. In this example, the transmittance of an OFF-state pixel is supposed to be zero and the transmittance of each ON-state pixel is supposed to be calculated by 1.0×(0.9)̂(the number of adjacent ON-state pixels). For example, since the ON-state pixel 168 that is located on the second column from the left and on the second row from the top has only one adjacent ON-state pixel, its transmittance is 1.0×(0.9)̂(1)=0.9. On the other hand, since the ON-state pixel 169 that is located on the fourth column from the left and on the fifth row from the top has three adjacent ON-state pixels, its transmittance is 1.0×(0.9)̂(3)=0.729, which is approximately equal to, and defined as, 0.73.

The transmittance changing section 163 performs this calculation on every ON-state pixel and puts zero for OFF-state pixels, thereby generating transmittance setting data 164.

The transmittance setting data 164 corresponds to the spatial light modulator on a pixel-by-pixel basis. And the optical signal beam that has been modulated by the spatial light modulator irradiates a holographic memory medium at intensities corresponding to the respective transmittances that have been set as described above.

The functions of the measuring section 162 and the transmittance changing section 163 may be performed by a microcontroller, for example. Alternatively, these functions may also be performed using, in combination, a circuit such as a counter and a ROM table including settings for the number of ON-state pixels and transmittance.

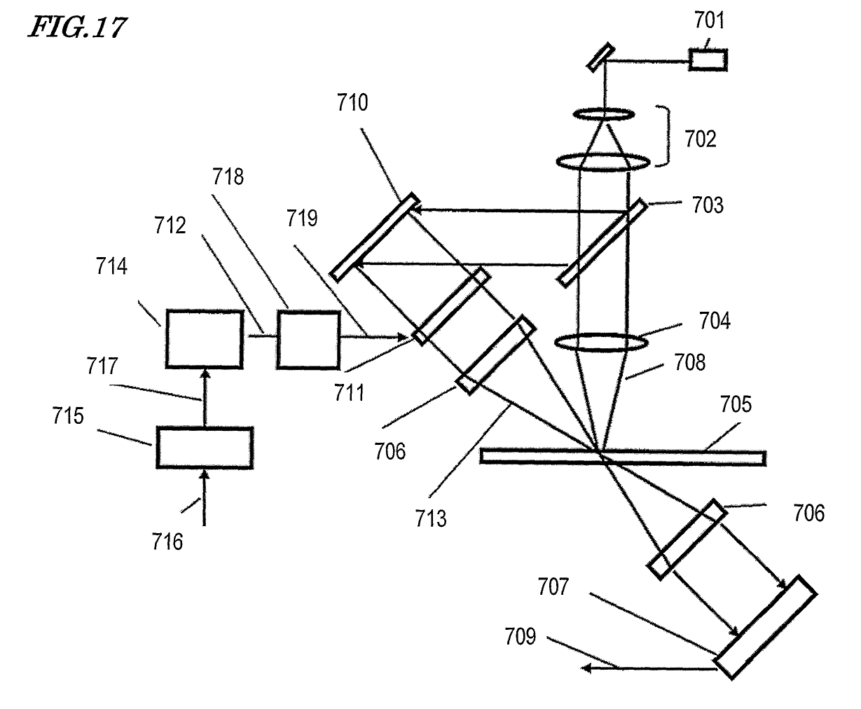

FIG. 17 is a block diagram showing an arrangement for a holographic memory device according to this preferred embodiment.

The holographic memory device of this preferred embodiment is different from the counterpart shown in FIG. 7 in that a transmittance setter 718 with the configuration shown in FIG. 16 is inserted between the two-dimensional encoder 714 and the spatial light modulator 711. Other than that, there is no difference between the two devices.

In the holographic memory device of this preferred embodiment, the transmittance setter 718 adjusts the transmittance of each ON-state pixel of the spatial light modulator 711 according to the number of its adjacent ON-state pixels. As a result, the influence of intersymbol interference to be caused by leakage of light into adjacent pixels can be weakened. The greater the number of adjacent ON-state pixels (i.e., the greater the influence of the intersymbol interference), the lower the transmittance of the spatial light modulator (i.e., the lower the intensity of the write light) is set to be. In this manner, the influence of the intersymbol interference can be weakened. And even if some ON-state pixels are adjacent to each other, read errors can still be reduced.

In the preferred embodiment described above, the four pixels that are vertically and horizontally adjacent to an ON-state pixel and the other four pixels that are diagonally adjacent to that ON-state pixel are treated as equivalent ones. However, these two groups of pixels may be treated differently. If an ON-state pixel is diagonally adjacent to a given ON-state pixel, read errors could be less likely to occur than a situation where there are vertically or horizontally adjacent ON-state pixels. In that case, there might be no need to count the number of ON-state pixels that are diagonally adjacent to a given ON-state pixel. Or even if the number of ON-state pixels that are diagonally adjacent to a given ON-state pixel needs to be counted, that number may be multiplied by a coefficient that is equal to or greater than zero but less than one.

By weighting the number of adjacent ON-state pixels according to their locations in this manner, the transmittance can be adjusted even more appropriately.

### INDUSTRIAL APPLICABILITY

The two-dimensional encoder, holographic memory device and holographic memory medium of the present invention can be used effectively to store a huge size of data.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A two-dimensional encoder for use to store data on a holographic memory, the encoder encoding data of k bits (where k is an integer and k≧3) into a number n of pixels that are arranged two-dimensionally (where n is an integer and n≧16), the encoder comprising:
a first processing section for classifying the n pixels into first and second groups of subblocks using k1 bits out of the data of k bits (where k1 is an integer and k1≧1), each of the subblocks in the first group consisting of a number m of pixels (where m is an integer and m≧2), the number of the subblocks forming the first group being s1 (where s1 is an integer and s1≧2), each of the subblocks in the second group also consisting of m pixels, the number of the subblocks forming the second group being s2 (where s2 is an integer and s2≧1); and
a second processing section for turning ON a number p of pixels (where p is an integer and 1≦p≦m/2) out of the m pixels forming each said subblock in the first group and turning OFF all of the m pixels forming each said subblock in the second group using the other k2 bits of the data of k bits (where k2=k−k1).

2. The two-dimensional encoder of claim 1, wherein m is one of 2, 4 and 16.

3. The two-dimensional encoder of claim 2, wherein if m=2 or 4, then p=1, but if m=16, then p=3.

4. The two-dimensional encoder of claim 3, wherein if m=2, then s1=9 and s2=6, and
wherein if m=4, then s1=5 and s2=13, and
wherein if m=16, then s1=3 and s2=1.

5. The two-dimensional encoder of claim 1, wherein k/n=0.5.

6. A two-dimensional encoder for use to store data on a holographic memory, the encoder generating two-dimensionally encoded data based on write data to be encoded,
wherein the two-dimensionally encoded data has a structure in which a number of subblocks are arranged in columns and rows, each said subblock including a first pixel and a second pixel that are arranged in the same order in a particular direction that is parallel to either the rows or the columns,
wherein the encoder comprises:
a first processing section for determining, based on the write data, the ON and OFF states of the subblocks; and
a second processing section for turning ON one of the first and second pixels in each of the subblocks that have been determined to turn ON among the subblocks,
wherein if the particular direction is parallel to the rows and if the subblock that has been determined to turn ON belongs to an odd-numbered row, the second processing section turns ON the first pixel of the subblock, but
if the subblock that has been determined to turn ON belongs to an even-numbered row, the second processing section turns ON the second pixel of the subblock, and
wherein if the particular direction is parallel to the columns and if the subblock that has been determined to turn ON belongs to an odd-numbered column, the second processing section turns ON the first pixel of the subblock, but
if the subblock that has been determined to turn ON belongs to an even-numbered column, the second processing section turns ON the second pixel of the subblock.

7. The two-dimensional encoder of claim 6, wherein the first processing section turns ON a number n of subblocks (where n is an integer and n≧1) among the subblocks, of which is the total number is m (where m is an integer and m≧2).

8. A holographic memory device for writing two-dimensionally encoded data on a holographic memory medium, the memory device comprising:
a light source for emitting an optical signal beam and a reference beam;
a spatial light modulator, which includes a plurality of pixels that are arranged two-dimensionally and which controls transmission and cutoff of the optical signal beam on a pixel-by-pixel basis, thereby turning ON or OFF the respective pixels;
the two-dimensional encoder of claim 1 for generating the two-dimensionally encoded data for use to drive the spatial light modulator; and
an optical system for irradiating the holographic memory medium with the reference beam and the optical signal beam that has been modulated by the spatial light modulator.

9. The holographic memory device of claim 8, further comprising:
a measuring section for counting the number of other ON-state pixels that are included in a plurality of pixels adjacent to each said ON-state pixel on the spatial light modulator; and
a transmittance changing section for adjusting the transmittance of each said ON-state pixel according to the number of the other ON-state pixels that are included in the pixels adjacent to the ON-state pixel.

10. The holographic memory device of claim 9, wherein if the transmittances of an OFF-state pixel, an ON-state pixel with no adjacent ON-state pixels, and an ON-state pixel with an adjacent ON-state pixel are identified by T0, T1 and T2, respectively, the transmittance changing section adjusts the transmittances of the respective pixels of the spatial light modulator such that T0<T2<T1 is satisfied.

11. The holographic memory device of claim 10, wherein the measuring section counts the number of the ON-state pixels included in eight pixels that are vertically, horizontally and diagonally adjacent to each said ON-state pixel.

12. The holographic memory device of claim 11, wherein if the number of the ON-state pixels included in the eight pixels that are vertically, horizontally and diagonally adjacent to each said ON-state pixel is n and if a is a predetermined number that is less than one, the transmittance changing section adjusts the transmittance of each said pixel of the spatial light modulator such that T2=T1×(a)̂n (where ̂ denotes a power) is satisfied.

13. The holographic memory device of claim 11, wherein in counting the number of the ON-state pixels included in eight pixels that are vertically, horizontally and diagonally adjacent to each said ON-state pixel, the measuring section multiplies the number of the ON-state pixels, included in the four pixels that are diagonally adjacent to the ON-state pixel, by a coefficient that is equal to or greater than zero but less than one.

14. A holographic memory medium for storing two-dimensionally encoded data, in which data of k bits (where k is an integer and k≧3) has been encoded into a number n of pixels that are arranged two-dimensionally (where n is an integer and n≧6),
wherein the n pixels are classified into first and second groups of subblocks, thereby representing k1 bits (where k1 is an integer and k1≧1) out of the data of k bits, each of the subblocks in the first group consisting of a number m of pixels (where m is an integer and m≧2), the number of the subblocks forming the first group being s1 (where s1 is an integer and s1≧2), each of the subblocks in the second group also consisting of m pixels, the number of the subblocks forming the second group being s2 (where s2 is an integer and s2≧1), and
wherein a number p of pixels (where p is an integer and 1≦p≦m/2) out of the m pixels forming each said subblock in the first group are ON-state pixels and all of the m pixels forming each said subblock in the second group are OFF-state pixels, thereby representing the other k2 bits of the data of k bits (where k2=k−k1) by the arrangement of the respective pixels in each said subblock.

15. A holographic memory medium for storing two-dimensionally encoded data,
wherein the two-dimensionally encoded data has a structure in which a number of subblocks are arranged in columns and rows, each said subblock including a first pixel and a second pixel that are arranged in the same order in a particular direction that is parallel to either the rows or the columns,
wherein if the particular direction is parallel to the rows and if a subblock including an ON-state pixel belongs to an odd-numbered row, the first pixel included in the subblock is selected as the ON-state pixel, but
if the subblock including the ON-state pixel belongs to an even-numbered row, the second pixel included in the subblock is selected as the ON-state pixel, and
wherein if the particular direction is parallel to the columns and if a subblock including an ON-state pixel belongs to an odd-numbered column, the first pixel included in the subblock is selected as the ON-state pixel, but
if the subblock including the ON-state pixel belongs to an even-numbered column, the second pixel included in the subblock is selected as the ON-state pixel.
